(19) United States
(12) Patent Application Publication
(10) Pub. No.: US 2022/0113530 A1
(43) Pub. Date: Apr. 14, 2022

(54) MICROSCOPE

(71) Applicant: Keyence Corporation, Osaka (JP)

(72) Inventor: Kenichiro HIROSE, Osaka (JP)

(73) Assignee: Keyence Corporation, Osaka (JP)

(21) Appl. No.: 17/466,271

(22) Filed: Sep. 3, 2021

(30) Foreign Application Priority Data
Oct. 14, 2020 (JP) 2020-173527

(51) Int. Cl. G02B 21/36

(52) U.S. Cl. CPC G02B 21/361; G02B 21/365; G02B 21/362

(57) ABSTRACT

An analysis and observation device includes: an observation optical system including an objective lens that has an observation optical axis and collects light from a sample placed on a placement stage, and a second camera that captures an image of the sample based on the light from the sample received through the objective lens; an electromagnetic wave emitter that emits an electromagnetic wave; a reflective object lens that has an analysis optical axis parallel to the observation optical axis and collects an electromagnetic wave and irradiates the sample with the collected electromagnetic wave, and collects light from the sample, and first and second detectors that generate an intensity distribution spectrum based on the electromagnetic wave collected by the reflective object lens; and a horizontal drive mechanism which moves relative positions of the observation optical system and the analysis optical system with respect to the placement stage along a horizontal direction.

### CROSS-REFERENCE TO RELATED APPLICATIONS

The present application claims foreign priority based on Japanese Patent Application No. 2020-173527, filed Oct. 14, 2020, the contents of which are incorporated herein by reference.

### BACKGROUND OF THE INVENTION

### 1. Field of the Invention

The technology disclosed herein relates to a microscope.

### 2. Description of Related Art

For example, JP 2020-101441 A discloses a device that performs component analysis using laser induced breakdown spectroscopy (LIBS). Specifically, the component measurement device disclosed in JP 2020-101441A is configured to perform component analysis of an observation target (specimen) by irradiating the observation target with laser light and receiving light (plasma light) generated in the observation target by a detector for analysis.

Furthermore, the component measurement device according to JP 2020-101441A is configured such that an observation optical system is arranged on an optical path from the observation target (specimen) to the detector to guide light to the detector through the observation optical system.

In the component measurement device disclosed in JP 2020-101441A, the observation optical system is arranged on the optical path from the analyte (specimen) to the detector.

Since the optimum optical design is different between an analysis optical system and the observation optical system, the observation optical system needs to be simplified if priority is given to analysis capability as an analysis device.

In order to observe an analyte in detail as in a microscope or to identify a position of the analyte in detail, it is preferable that an observation image captured by an appropriate observation optical system can be acquired. It is also conceivable to switch between analysis and observation by switching between an objective lens for analysis and an objective lens for observation with a revolver or the like. In such a configuration, however, a mechanical mechanism for switching between an analysis optical system and an observation optical system is required on an optical path, an optical design becomes complicated, and it becomes difficult to achieve both sufficient analysis capability and observation capability.

### SUMMARY OF THE INVENTION

The technology disclosed herein has been made in view of such points, and an object thereof is to improve usability of a microscope.

One embodiment of the present disclosure relates to a microscope that performs magnifying observation of an observation target. The microscope includes: a placement stage on which an observation target is placed; an observation optical system including a first objective lens that collects light from the observation target placed on the placement stage, and a camera that detects a light reception amount of the light from the observation target received through the first objective lens to capture an image of the observation target; an analysis optical system including an electromagnetic wave emitter that emits an electromagnetic wave for analyzing the observation target, a second objective lens that collects an electromagnetic wave from the observation target in response to irradiation of the electromagnetic wave, and a detector that generates an intensity distribution spectrum which is an intensity distribution for each wavelength of the electromagnetic wave generated in the observation target and collected by the second objective lens; and a horizontal drive mechanism which moves relative positions of the observation optical system and the analysis optical system with respect to the placement stage along a horizontal direction such that the capturing of the observation target by the observation optical system and the irradiation of the electromagnetic wave by the analysis optical system are executable on an identical point in the observation target.

Here, the term “movement along the horizontal direction” includes not only linear movement in a front-rear direction, a left-right direction, and the like but also curved movement such as rotation along a horizontal plane.

According to the one embodiment, the microscope moves the relative positions of the observation optical system and the analysis optical system with respect to the placement stage to execute the capturing of the observation target by the observation optical system and the emission of the electromagnetic wave during the generation of the intensity distribution spectrum by the analysis optical system on the identical point in the observation target. As a result, it is possible to eliminate a deviation between an observation position by the observation optical system and an analysis position by the analysis optical system, and eventually, it is possible to improve the usability of the device.

Further, according to the one embodiment, the observation optical system and the analysis optical system are configured as independent optical systems, and thus, each of the optical systems can have a specification suitable for each application. As a result, the performance of each of the optical systems can be optimized as much as possible.

Further, according to another embodiment of the present disclosure, the microscope may include a stand to which the placement stage, the observation optical system, and the analysis optical system are attachable.

According to the another embodiment, the microscope can be configured as an all-in-one-type microscope, and can be implemented from observation to analysis only by attaching the respective optical systems to the stand. This is advantageous in terms of improving the usability of the device.

Further, according to still another embodiment of the present disclosure, an optical axis of the first objective lens and an optical axis of the second objective lens may be provided so as to be parallel to each other, and the capturing of the observation target by the observation optical system and the irradiation of the electromagnetic wave by the analysis optical system may be executed on the identical point from an identical direction before and after movement, the movement of the relative position in the horizontal direction being caused by the horizontal drive mechanism.

Further, according to still another embodiment of the present disclosure, the microscope may include: an observation unit accommodating the observation optical system; and a lens barrel holder which fixes the observation unit with respect to the analysis optical system to fix a relative position of an optical axis of the second objective lens with respect to an optical axis of the first objective lens.

According to the still another embodiment, the relative position of the optical axis of the second objective lens with respect to the optical axis of the first objective lens is constant, and thus, it is possible to perform the observation and analysis on the identical point by relatively moving the observation optical system and the analysis optical system by a distance corresponding to the relative position.

Further, according to still another embodiment of the present disclosure, the respective optical axes of the observation optical system and the analysis optical system may be arranged side by side along a direction in which the observation optical system and the analysis optical system relatively are moved with respect to the placement stage by the horizontal drive mechanism as the lens barrel holder holds the observation unit.

According to the still another embodiment, arranging the two optical axes side by side along a direction of the movement caused by the horizontal drive mechanism is advantageous in terms of performing observation and analysis on the identical point.

Further, according to still another embodiment of the present disclosure, the microscope may include an analysis housing that accommodates the analysis optical system, and the lens barrel holder in a state of holding the observation unit may be arranged outside the analysis housing.

According to the still another embodiment, the analysis optical system and the observation optical system can be formed as completely independent optical units, which is advantageous in terms of setting the specifications suitable for the respective applications.

Here, the observation unit is attached to an outer surface of the analysis housing via the lens barrel holder, and thus, it becomes easy to replace the entire observation optical system together with observation unit, and at the same time, it becomes extremely easy to replace a part of the observation optical system (for example, an objective lens) by manual work or the like. This is advantageous in terms of improving the usability of the device.

Further, according to still another embodiment of the present disclosure, the lens barrel holder may be configured to selectively hold any one of a plurality of types of the observation units accommodating the observation optical systems different from each other.

According to the still another embodiment, it is easy to replace the observation optical system having desired characteristics, such as a magnification of the first objective lens, together with the observation unit, which is advantageous in terms of improving the usability of the device.

Further, according to still another embodiment of the present disclosure, the microscope may be configured such that the horizontal drive mechanism is operated to switch between a first mode in which the first objective lens faces the observation target and a second mode in which the second objective lens faces the observation target, and image generation of the observation target by the observation optical system and the irradiation of the electromagnetic wave by the analysis optical system are performed on the identical point from an identical direction at timings before and after the switching between the first mode and the second mode.

According to the still another embodiment, observation and analysis for the observation target can be performed from the same angle before and after the movement caused by the horizontal movement mechanism. As a result, the deviation between the observation position by the observation optical system and the analysis position by the analysis optical system is further eliminated, which is more advantageous in terms of improving the usability of the device.

Further, according to still another embodiment of the present disclosure, the microscope may include a controller electrically connected to the observation optical system and the analysis optical system, and the controller may be configured to be capable of executing both of generation of image data of the observation target based on a light reception amount of the light from the observation target and analysis of a substance contained in the observation target based on the intensity distribution spectrum.

According to the still another embodiment, the controller that performs processing related to the observation optical system and the controller that performs processing related to the analysis optical system are common. As a result, it is possible to share a control system while providing the two independent optical systems, and it is possible to reduce the number of components and smoothly execute the processing related to both of the two optical systems.

Further, according to still another embodiment of the present disclosure, the microscope may include: a plurality of types of observation units accommodating the observation optical systems different from each other; and a lens barrel holder that fixes any one of the plurality of types of the observation units with respect to the analysis optical system to fix a relative position of an optical axis of the second objective lens with respect to an optical axis of the first objective lens, and the controller may identify at least a type of the first objective lens among types of the observation optical system corresponding to the observation unit fixed to the analysis optical system by the lens barrel holder, and execute processing related to the capturing of the observation target based on the identification result.

According to the still another embodiment, various processes can be automated according to the type of the objective lens, which is advantageous in terms of improving the usability of the device.

Further, according to still another embodiment of the present disclosure, the electromagnetic wave emitter may include a laser light source that emits laser light as the electromagnetic wave.

According to the still another embodiment, component analysis can be performed based on various methods using the laser light, such as an LIBS method.

Further, according to still another embodiment of the present disclosure, the second objective lens may collect plasma generated from the observation target in response to the irradiation of the laser light emitted by the electromagnetic wave emitter, and the detector may generate an intensity distribution spectrum which is an intensity distribution for each wavelength of the plasma generated in the observation target and collected by the second objective lens.

Further, according to still another embodiment of the present disclosure, the microscope may include a tilting mechanism that tilts the analysis optical system and the observation optical system together with respect to a predetermined reference axis perpendicular to an upper surface of the placement stage.

According to the still another embodiment, the tilting mechanism tilts at least the observation optical system between the analysis optical system and the observation optical system with respect to a predetermined reference axis perpendicular to an upper surface of the placement stage. As the tiltable observation optical system is mounted on the microscope, the observation target can be observed from various angles such as an oblique direction. As a result, a user can easily grasp the observation position of the observation target.

As described above, the usability of the microscope can be improved according to the present disclosure.

### BRIEF DESCRIPTION OF THE DRAWINGS

FIG. 1 is a schematic diagram illustrating an overall configuration of an analysis and observation device;

FIG. 2 is a perspective view illustrating an optical system main body;

FIG. 3 is a side view illustrating the optical system main body;

FIG. 4 is a front view illustrating the optical system main body;

FIG. 5 is an exploded perspective view illustrating the optical system main body;

FIG. 6 is a side view schematically illustrating a configuration of the optical system main body;

FIG. 7 is a schematic view illustrating a configuration of an analysis unit;

FIG. 8 is a perspective view illustrating a configuration of a unit coupler;

FIG. 9 is a schematic view for describing attachment and detachment of a lens barrel;

FIG. 10 is a schematic view for describing a configuration of a unit switching mechanism as viewed from above;

FIG. 11A is a view for describing horizontal movement of a head;

FIG. 11B is a view for describing the horizontal movement of the head;

FIG. 12A is a view for describing an operation of a tilting mechanism;

FIG. 12B is a view for describing the operation of the tilting mechanism;

FIG. 13 is a block diagram illustrating a configuration of a controller main body;

FIG. 14 is a block diagram illustrating a configuration of a controller;

FIG. 15A is a flowchart illustrating a basic operation of the analysis and observation device;

FIG. 15B is a flowchart illustrating an analyte search procedure by an observation unit;

FIG. 15C is a flowchart illustrating a sample analysis procedure by the analysis unit;

FIG. 16A is a view illustrating a display screen of the analysis and observation device;

FIG. 16B is a view illustrating the display screen of the analysis and observation device;

FIG. 16C is a view illustrating the display screen of the analysis and observation device;

FIG. 16D is a view illustrating the display screen of the analysis and observation device;

FIG. 16E is a view illustrating the display screen of the analysis and observation device;

FIG. 16F is a view illustrating the display screen of the analysis and observation device; and

FIG. 17 is a view illustrating a state where a shielding cover is attached to the head.

### DETAILED DESCRIPTION OF PREFERRED EMBODIMENTS

Hereinafter, an embodiment of the present disclosure will be described with reference to the drawings. Note that the following description is given as an example.

<Overall Configuration of Analysis and Observation Device A>

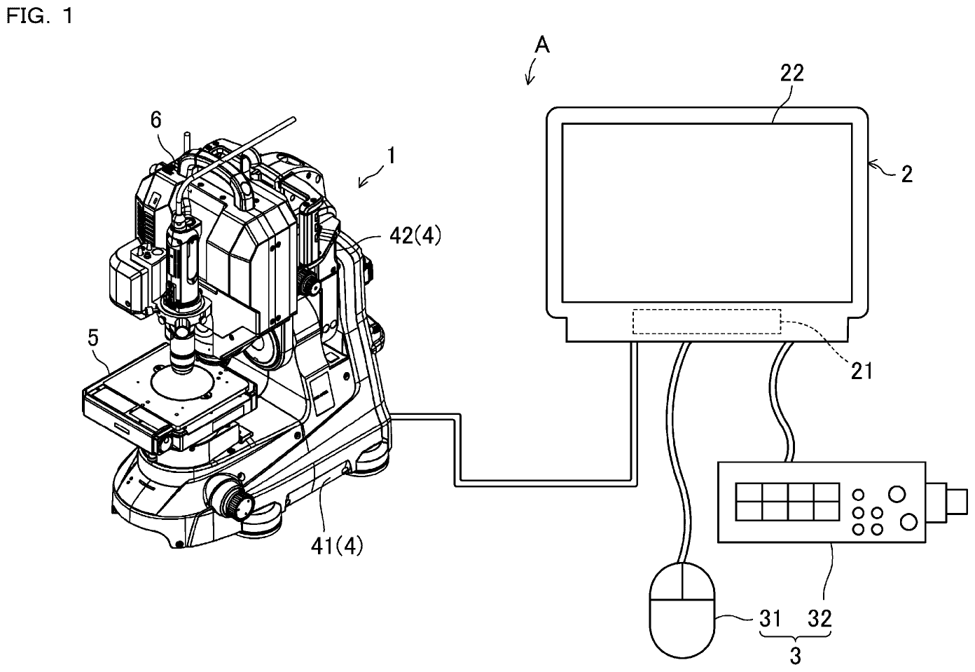

FIG. 1 is a schematic diagram illustrating an overall configuration of an analysis and observation device A as a microscope according to an embodiment of the present disclosure. The analysis and observation device A illustrated in FIG. 1 can perform magnifying observation of a sample SP, which serves as both of an observation target and an analyte, and can also perform component analysis of the sample SP.

Specifically, for example, the analysis and observation device A according to the present embodiment can search for a site where component analysis is to be performed in the sample SP and perform inspection, measurement, and the like of an appearance of the site by magnifying and capturing an image of the sample SP including a specimen such as a micro object, an electronic component, a workpiece, and the like. When focusing on an observation function, the analysis and observation device A can be referred to as a magnifying observation device, simply as a microscope, or as a digital microscope.

The analysis and observation device A can also perform a method referred to as a laser induced breakdown spectroscopy (LIBS), laser induced plasma spectroscopy (LIPS), or the like in the component analysis of the sample SP. When focusing on an analysis function, the analysis and observation device A can be referred to as a component analysis device, simply as an analysis device, or as a spectroscopic device.

As illustrated in FIG. 1, the analysis and observation device A according to the present embodiment includes an optical system unit group 1, a controller main body 2, and an operation section 3 as main constituent elements.

Among them, the optical system unit group 1 can perform capturing and analysis of the sample SP and output an electrical signal corresponding to a capturing result and an analysis result to the outside.

The controller main body 2 includes a controller 21 configured to control various components constituting the optical system unit group 1 such as a first camera 81. The controller main body 2 can cause the optical system unit group 1 to observe and analyze the sample SP using the controller 21. The controller main body 2 also includes a display 22 capable of displaying various types of information. The display 22 can display an image captured in the optical system unit group 1, data indicating the analysis result of the sample SP, and the like.

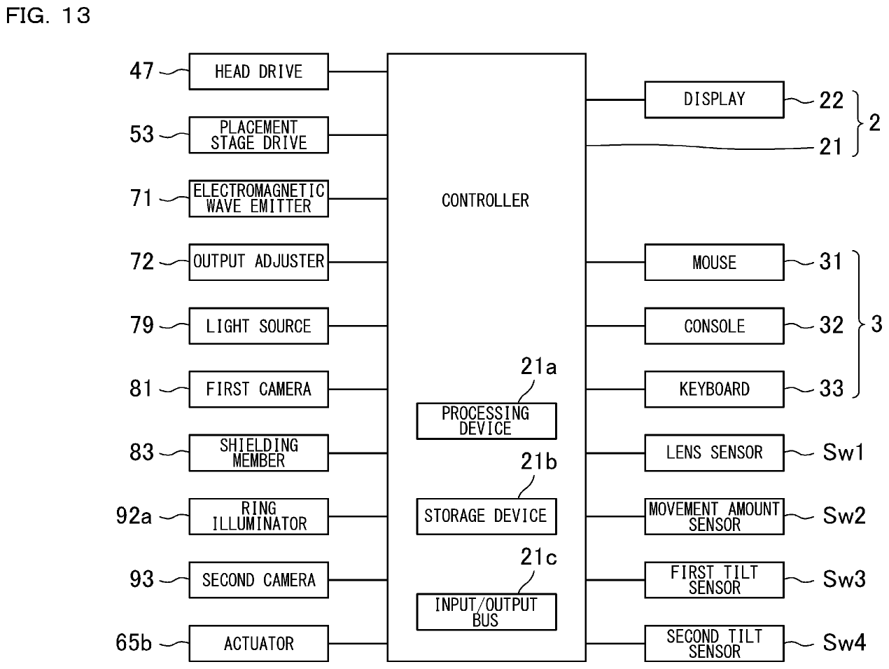

The operation section 3 includes a mouse 31, a console 32, and a keyboard 33 that receive an operation input by a user (the keyboard 33 is illustrated only in FIG. 13). The console 32 can instruct acquisition of image data, brightness adjustment, and focusing of the first camera 81 to the controller main body 2 by operating a button, an adjustment knob, and the like.

Note that the operation section 3 does not necessarily include all three of the mouse 31, the console 32, and the keyboard 33, and may include any one or two. Further, a touch-panel-type input device, an audio-type input device, or the like may be used in addition to or instead of the mouse 31, the console 32, and the keyboard 33. In the case of the touch-panel-type input device, any position on a screen displayed on the display 22 can be detected.

<Details of Optical System Unit Group 1>

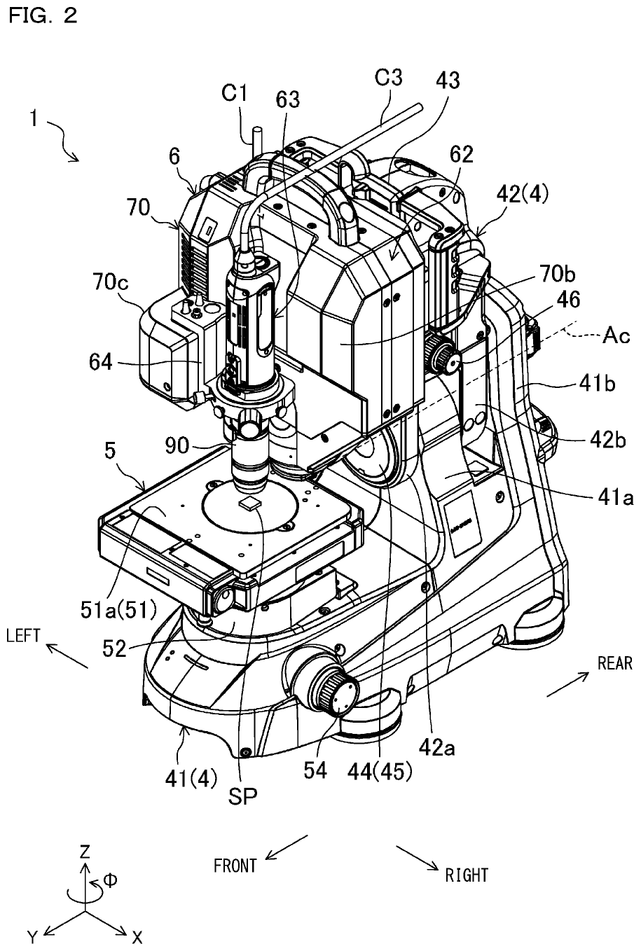

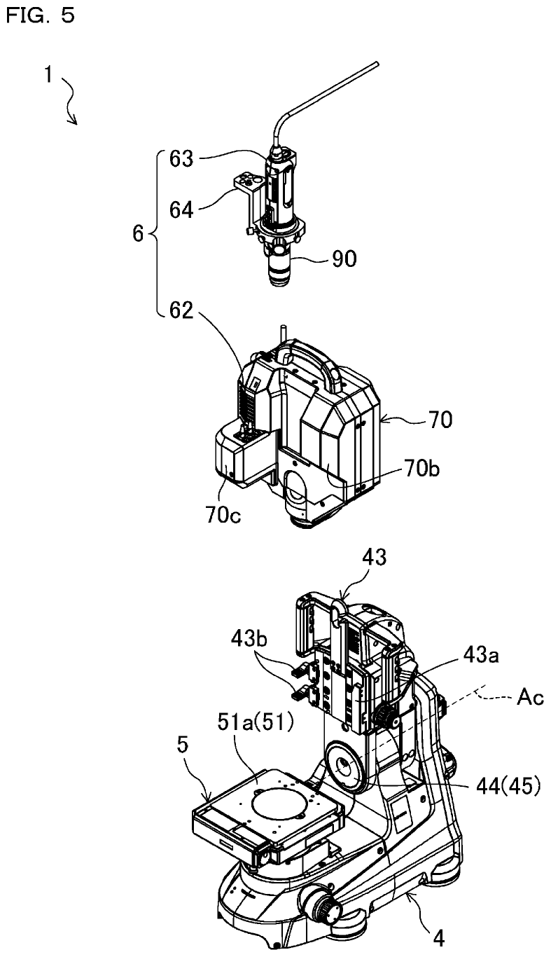

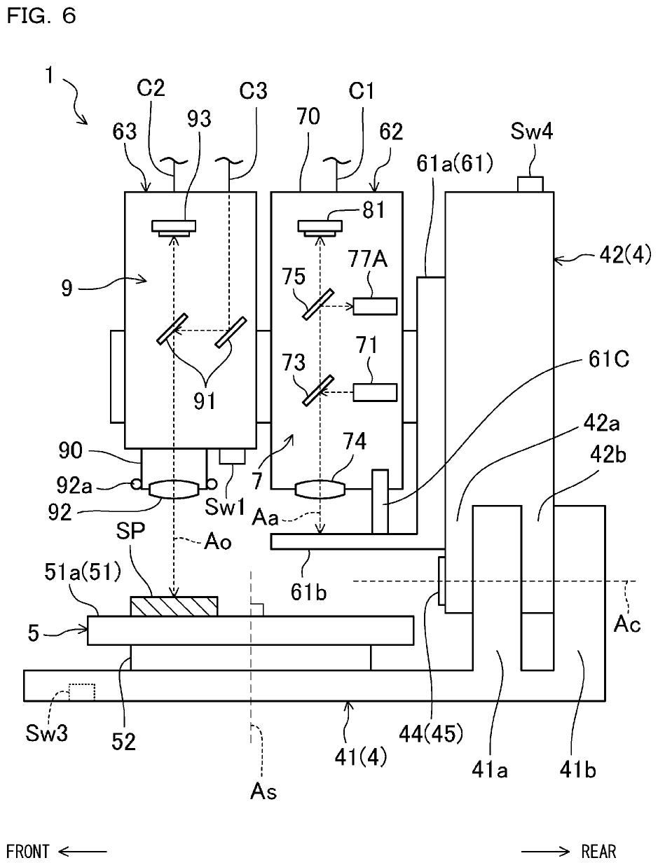

FIGS. 2 to 4 are a perspective view, a side view, and a front view respectively illustrating the optical system unit group 1. Further, FIG. 5 is an exploded perspective view of the optical system unit group 1, and FIG. 6 is a side view schematically illustrating a configuration of the optical system unit group 1.

As illustrated in FIGS. 1 to 6, the optical system unit group 1 includes a stand 4 configured to support various devices, and a stage 5 and a head 6 attached to the stand 4. Here, the head 6 is formed by mounting an observation unit 63 in which an observation optical system 9 is accommodated onto an analysis unit 62 in which an analysis optical system 7 is accommodated. Here, the analysis optical system 7 is an optical system configured to perform the component analysis of the sample SP. The observation optical system 9 is an optical system configured to perform the magnifying observation of the sample SP. The head 6 is configured as a device group having both of an analysis function and a magnifying observation function of the sample SP.

Note that the front-rear direction and the left-right direction of the optical system unit group 1 are defined as illustrated in FIGS. 1 to 4 in the following description. That is, one side opposing the user is a front side of the optical system unit group 1, and an opposite side thereof is a rear side of the optical system unit group 1. When the user opposes the optical system unit group 1, a right side as viewed from the user is a right side of the optical system unit group 1, and a left side as viewed from the user is a left side of the optical system unit group 1. Note that the definitions of the front-rear direction and the left-right direction are intended to help understanding of the description, and do not limit an actual use state. Any direction may be used as the front.

Further, in the following description, the left-right direction of the optical system unit group 1 is defined as an “X direction”, the front-rear direction of the optical system unit group 1 is defined as a “Y direction”, a vertical direction of the optical system unit group 1 is defined as a “Z direction”, and a direction rotating about an axis parallel to the Z axis is defined as a “φ direction”. The X direction and the Y direction are orthogonal to each other on the same horizontal plane, and a direction along the horizontal plane is defined as a “horizontal direction”. The Z axis is a direction of a normal line orthogonal to the horizontal plane. These definitions can also be changed as appropriate.

Although not described in detail, the head 6 can move along a central axis Ac illustrated in FIGS. 2 to 6 or swing about the central axis Ac. As illustrated in FIG. 6 and the like, the central axis Ac extends along the above-described horizontal direction, particularly the front-rear direction.

(Stand 4)

The stand 4 includes a base 41 placed on a workbench or the like, and a strut 42 extending upward from a rear side portion of the base 41. The stand 4 is a member configured to define a positional relation between the stage 5 and the head 6, and is configured such that at least the placement stage 51 of the stage 5 and the observation optical system 9 and the analysis optical system 7 of the head 6 are attachable thereto.

The base 41 forms a substantially lower half of the stand 4, and is formed in a pedestal shape such that a dimension in the front-rear direction is longer than a dimension in the left-right direction as illustrated in FIG. 2. The stage 5 is attached to a front portion of the base 41.

Further, a first supporter 41a and a second supporter 41b are provided in a state of being arranged side by side in order from the front side on the rear side portion (in particular, a portion located on the rear side of the stage 5) of the base 41 as illustrated in FIG. 6 and the like. Both the first and second supporters 41a and 41b are provided so as to protrude upward from the base 41. Circular bearing holes (not illustrated) arranged to be concentric with the central axis Ac are formed in the first and second supporters 41a and 41b.

The strut 42 forms a substantially upper half of the stand 4, and is formed in a columnar shape extending along the vertical direction as illustrated in FIGS. 2 to 3, 6, and the like. The head 6 is attached to a front surface of an upper portion of the strut 42 via a separate mounting tool 43.

Further, a first attachment section 42a and a second attachment section 42b are provided in a lower portion of the strut 42 in a state of being arranged side by side in order from the front side as illustrated in FIG. 6 and the like. The first and second attachment sections 42a and 42b have configurations corresponding to the first and second supporters 41a and 41b, respectively. Specifically, the first and second supporters 41a and 41b and the first and second attachment sections 42a and 42b are laid out such that the first attachment section 41a is sandwiched between the first attachment section 42a and the second attachment section 42b and the second attachment section 42b is sandwiched between the first supporter 41a and the second supporter 41b.

Further, circular bearing holes (not illustrated) concentric with and having the same diameter as the bearing holes formed in the first and second attachment sections 42a and 42b are formed in the first and second supporters 41a and 41b. A shaft member 44 is inserted into these bearing holes via a bearing (not illustrated) such as a cross-roller bearing. The shaft member 44 is arranged such that the axis thereof is concentric with the central axis Ac. The base 41 and the strut 42 are coupled so as to be relatively swingable by inserting the shaft member 44. The shaft member 44 forms a tilting mechanism 45 in the present embodiment together with the first and second supporters 41a and 41b and the first and second attachment sections 42a and 42b.

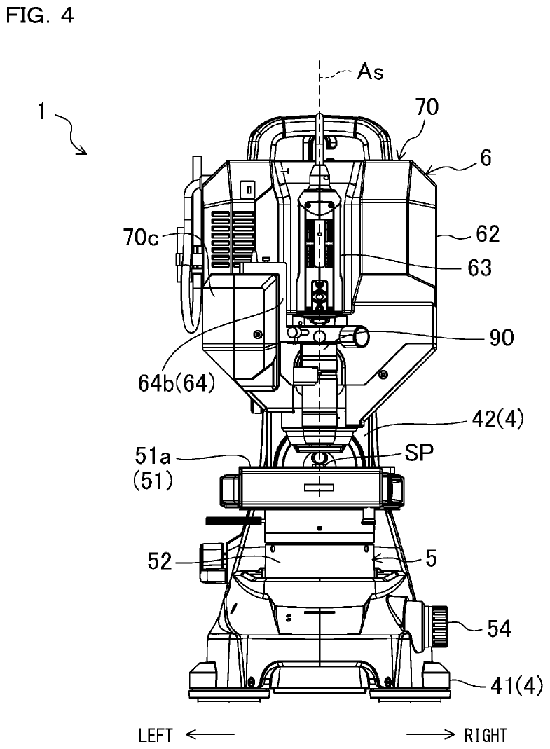

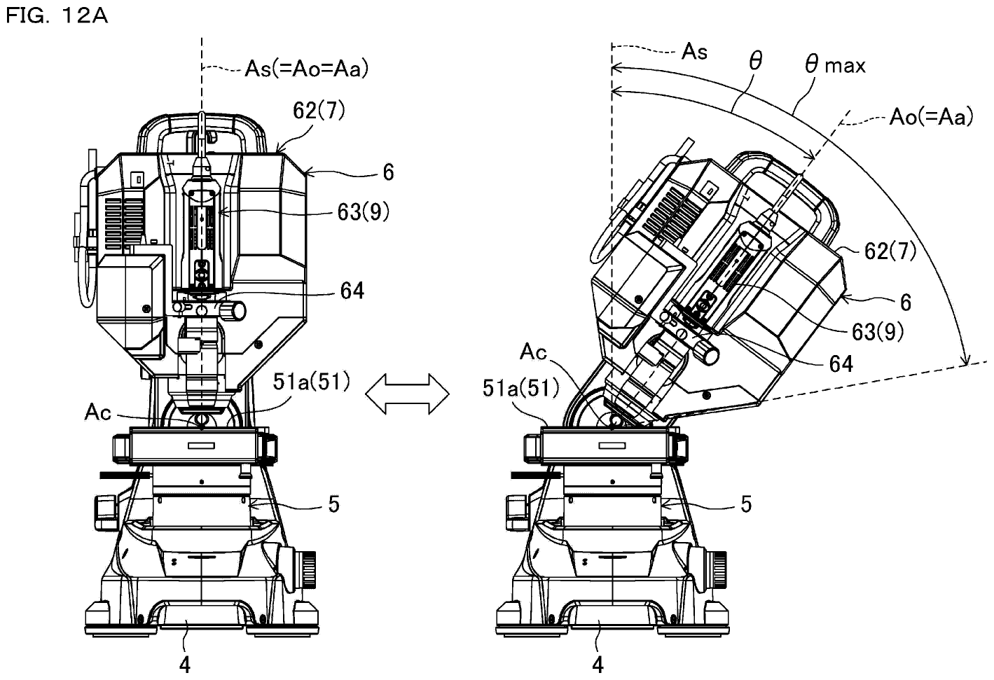

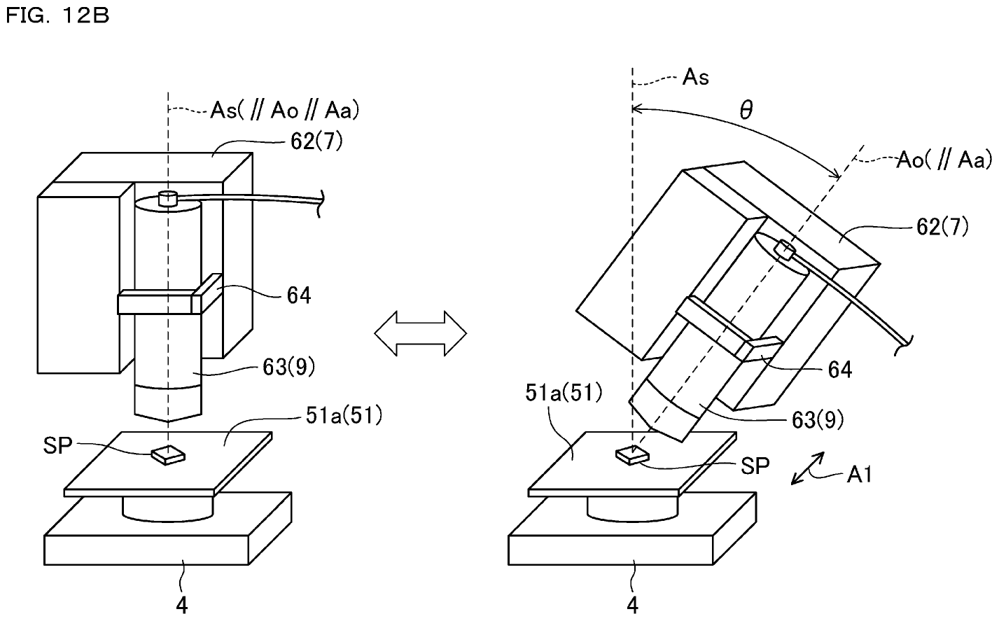

As the base 41 and the strut 42 are coupled via the tilting mechanism 45, the strut 42 is supported by the base 41 in the state of being swingable about the central axis Ac. The strut 42 swings about the central axis Ac to be tilted in the left-right direction with respect to a predetermined reference axis As (see FIGS. 12A and 12B). The reference axis As can be set as an axis extending perpendicularly to an upper surface (placement surface 51a) of the stage 5 in a non-tilted state illustrated in FIG. 4 and the like. Further, the central axis Ac functions as a central axis (rotation center) of swing caused by the tilting mechanism 45.

Specifically, the tilting mechanism 45 according to the present embodiment can tilt the strut 42 rightward by about 90° or leftward by about 60° with respect to the reference axis As. Since the head 6 is attached to the strut 42 as described above, the head 6 can also be tilted in the left-right direction with respect to the reference axis As. Tilting the head 6 is equivalent to tilting the analysis optical system 7 and the observation optical system 9, and eventually, tilting an analysis optical axis Aa and an observation optical axis Ao which will be described later.

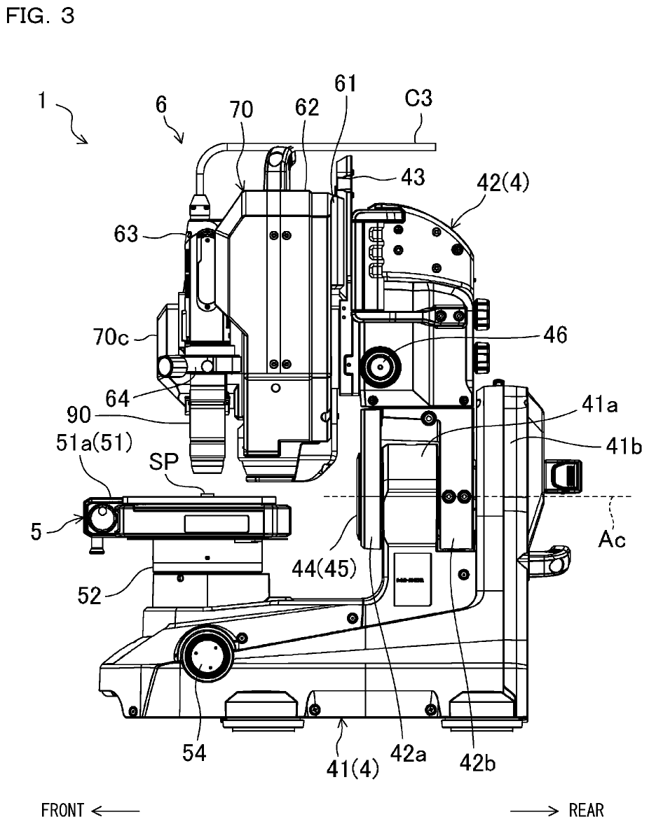

The mounting tool 43 includes: a rail 43a that guides the head 6 along a longitudinal direction (which corresponds to the vertical direction in the non-tilted state and will be hereinafter referred to as a “substantially vertical direction”) of the strut 42; and a lock lever 43b configured to lock a relative position of the head 6 with respect to the rail 43a. A rear surface portion (specifically, an attachment plate 61) of the head 6 is inserted into the rail 43a, and can be moved along the substantially vertical direction. Then, the head 6 can be fixed at a desired position by operating the lock lever 43b in a state where the head 6 is set at a desired position. Further, the position of the head 6 can also be adjusted by operating a first operation dial 46 illustrated in FIGS. 2 to 3.

Further, the stand 4 or the head 6 incorporates a head drive 47 configured to move the head 6 in the substantially vertical direction. The head drive 47 includes an actuator (for example, a stepping motor) (not illustrated) controlled by the controller main body 2 and a motion conversion mechanism that converts the rotation of an output shaft of the stepping motor into a linear motion in the substantially vertical direction, and moves the head 6 based on a drive pulse input from the controller main body 2. When the head drive 47 moves the head 6, the head 6, and eventually, the analysis optical axis Aa and the observation optical axis Ao can be moved along the substantially vertical direction.

(Stage 5)

The stage 5 is arranged on the front side of the center of the base 41 in the front-rear direction, and is attached to an upper surface of the base 41. The stage 5 is configured as an electric placement stage, and can cause the sample SP placed on the placement surface 51a to move along the horizontal direction, to move up and down along the vertical direction, or to rotate along the cp direction.

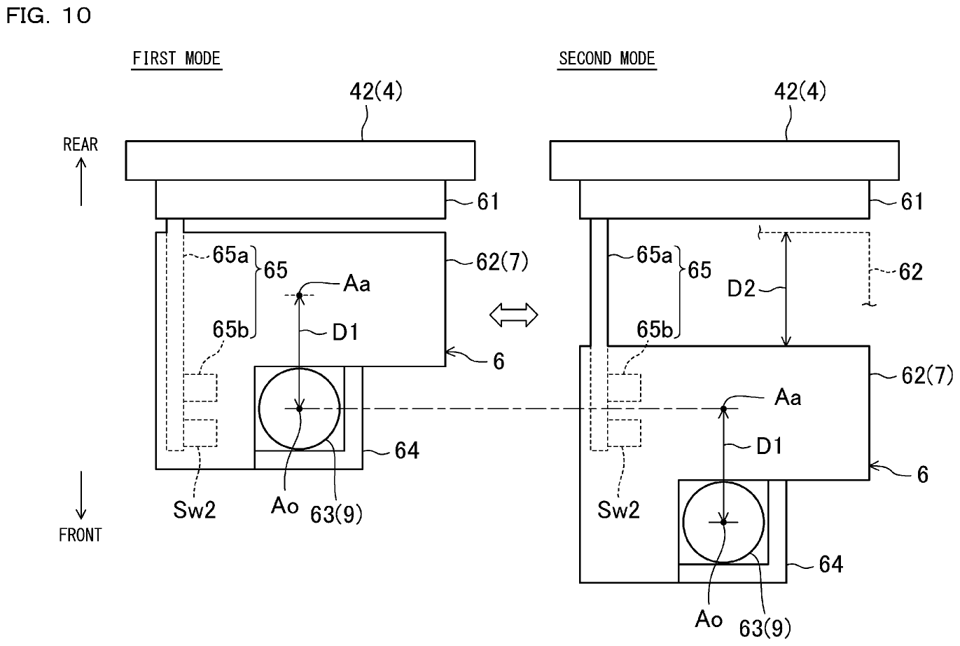

Specifically, the stage 5 according to the present embodiment includes: the placement stage 51 having the placement surface 51a configured for mounting of the sample SP; a placement stage supporter 52 that is arranged between the base 41 and the placement stage 51 and displaces the placement stage 51; and a placement stage drive 53 illustrated in FIG. 10 which will be described later.

An upper surface of the placement stage 51 forms the placement surface 51a. The placement surface 51a is formed to extend along the substantially horizontal direction. The sample SP is placed on the placement surface 51a in an atmospheric open state, that is, in a state of not being accommodated in a vacuum chamber or the like.

The placement stage supporter 52 is a member that couples the base 41 and the placement stage 51, and is formed in a substantially columnar shape extending along the vertical direction. The placement stage supporter 52 can accommodate the placement stage drive 53.

The placement stage drive 53 includes a plurality of actuators (for example, stepping motors) (not illustrated) controlled by the controller main body 2 and a motion conversion mechanism that converts the rotation of an output shaft of each stepping motor into a linear motion, and moves the placement stage 51 based on a drive pulse input from the controller main body 2. As the placement stage 51 is moved by the placement stage drive 53, the placement stage 51, and eventually, the sample SP placed on the placement surface 51a can be moved along the horizontal direction and the vertical direction.

Similarly, the placement stage drive 53 can also rotate the placement stage 51 along the φ direction based on a drive pulse input from the controller main body 2. As the placement stage drive 53 rotates the placement stage 51, the sample SP placed on the placement surface 51a can be rotated in the φ direction.

Further, the placement stage 51 can be manually moved and rotated by operating a second operation dial 54 or the like illustrated in FIG. 2. Details of the second operation dial 54 are omitted.

Returning to the description of the stand 4, a first tilt sensor Sw3 is incorporated in the base 41. The first tilt sensor Sw3 can detect a tilt of the reference axis As perpendicular to the placement surface 51a with respect to the direction of gravity. On the other hand, a second tilt sensor Sw4 is attached to the strut 42. The second tilt sensor Sw4 can detect a tilt of the analysis optical system 7 with respect to the direction of gravity (more specifically, a tilt of the analysis optical axis Aa with respect to the direction of gravity). Detection signals of the first tilt sensor Sw3 and the second tilt sensor Sw4 are both input to the controller 21. The first tilt sensor Sw3 and the second tilt sensor Sw4 constitute a “tilt detector” in the present embodiment.

(Head 6)

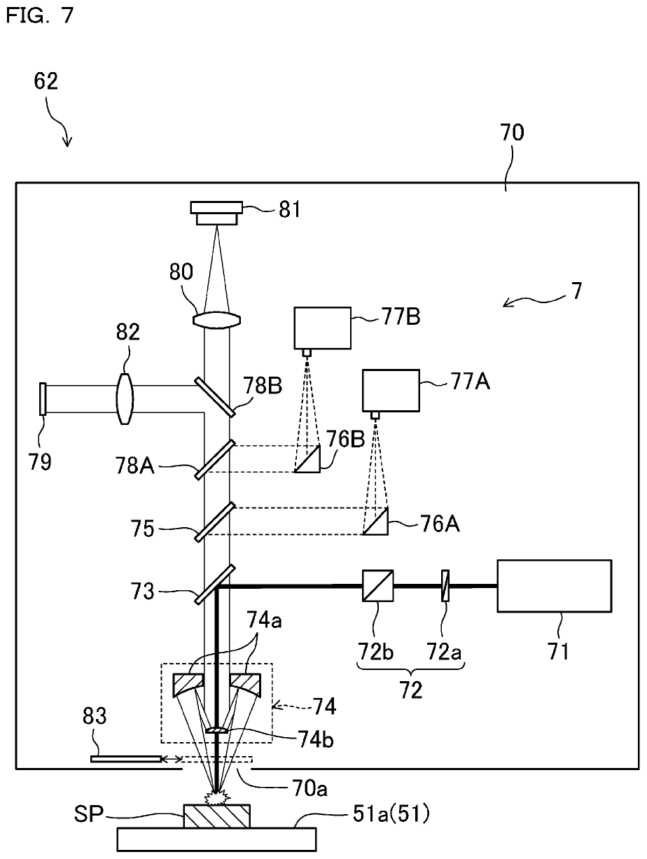

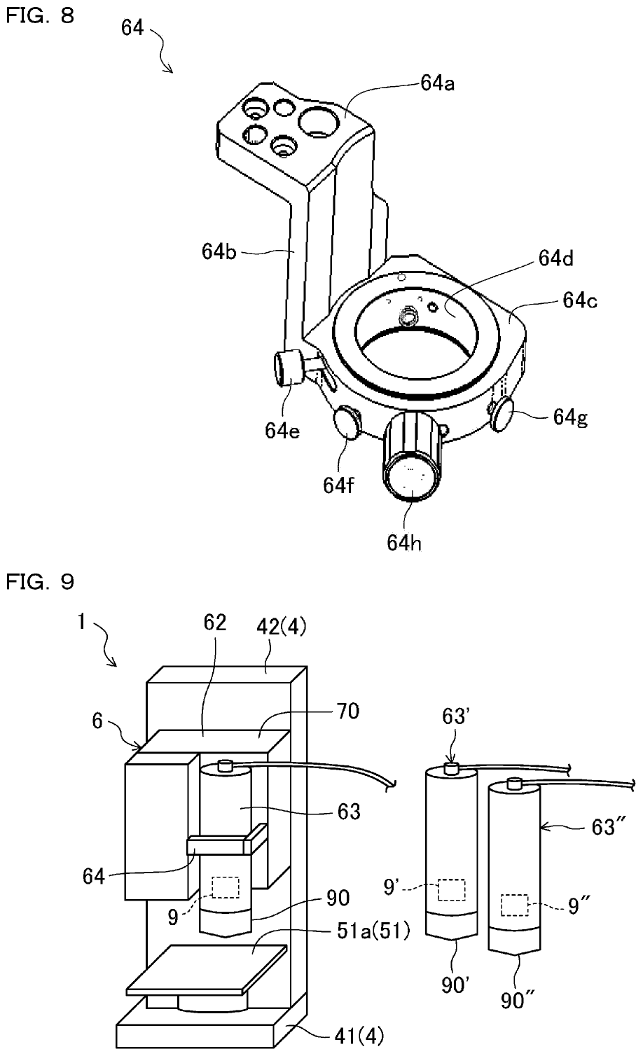

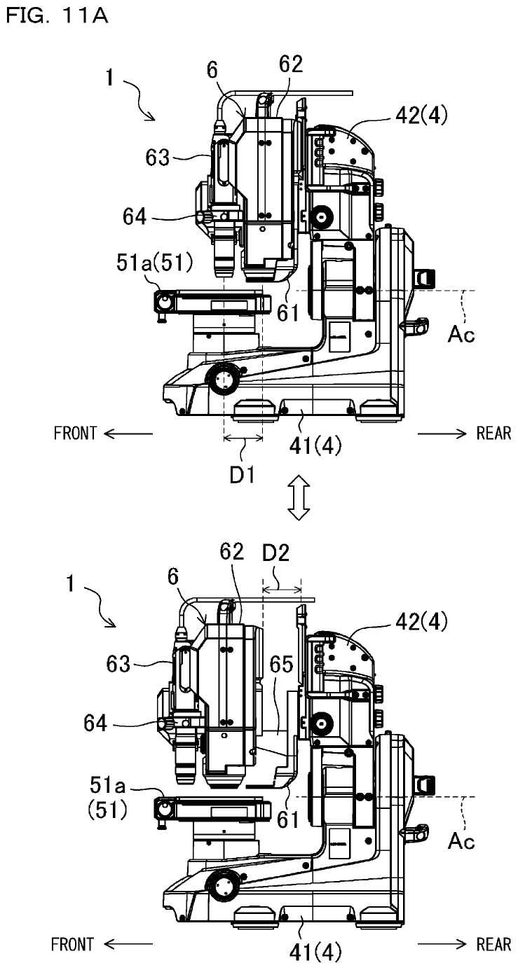

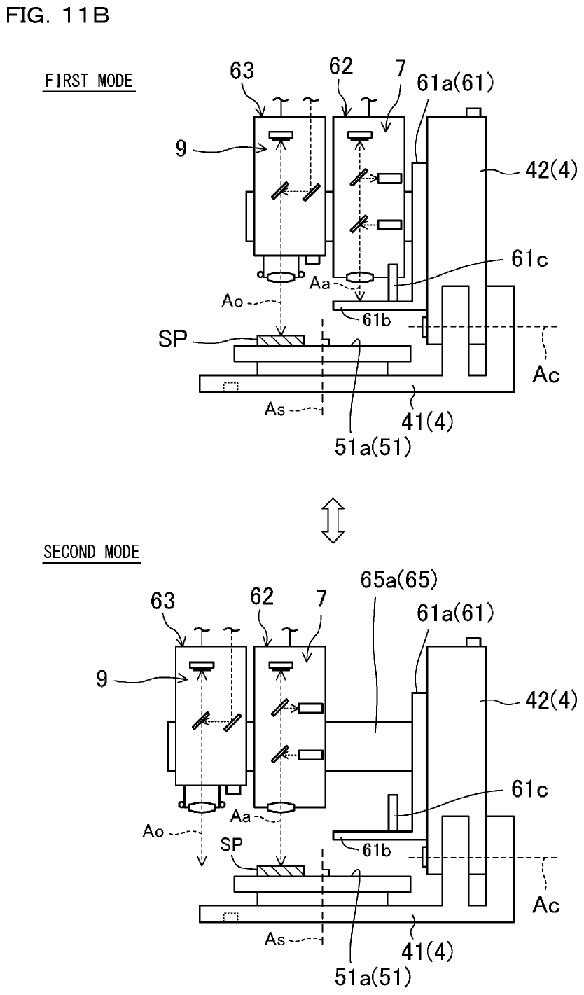

FIG. 7 is a schematic view illustrating a configuration of the analysis unit 62. Further, FIG. 8 is a perspective view illustrating a configuration of a unit coupler 64, and FIG. 9 is a schematic view for describing attachment and detachment of the observation unit 63. Further, FIG. 10 is a schematic view for describing a configuration of a unit switching mechanism 65 as viewed from above. Further, FIGS. 11A and 11B are views for describing horizontal movement of the head 6.

The head 6 includes the attachment plate 61, the analysis unit 62, the observation unit 63, the unit coupler 64 as a lens barrel holder, and the unit switching mechanism 65 as a horizontal drive mechanism.

The attachment plate 61 is arranged on the rear side of the head 6, and is configured as a plate-like member for mounting the head 6 to the stand 4. As described above, the attachment plate 61 is fixed to the mounting tool 43 of the stand 4.

The attachment plate 61 includes: a plate main body 61a extending substantially parallel to a rear surface of the head 6; a cover member 61b protruding forward from a lower end of the plate main body 61a; and a connector 61c attached to the cover member 61b. Details of the cover member 61b and the connector 61c will be described later.

Further, a guide rail 65a forming the unit switching mechanism 65 is attached to a left end of the attachment plate 61 as illustrated in FIG. 10. The guide rail 65a couples the attachment plate 61 and other elements (specifically, the analysis unit 62, the observation unit 63, and the unit coupler 64) in the head 6 so as to be relatively displaceable in the horizontal direction.

Hereinafter, configurations of the analysis unit 62, the observation unit 63, the unit coupler 64, and the unit switching mechanism 65 will be sequentially described.

—Analysis Unit 62—

The analysis unit 62 includes an analysis optical system 7 configured to analyze the sample SP and an analysis housing 70 accommodating the analysis optical system 7. The analysis optical system 7 is a set of components configured to analyze the sample SP as an analyte, and the respective components are accommodated in the analysis housing 70. The analysis optical system 7 can perform analysis using, for example, an LIBS method. A communication cable C1, configured to transmit and receive an electrical signal to and from the controller main body 2, is connected to the analysis unit 62. The communication cable C1 is not essential, and the analysis unit 62 and the controller main body 2 may be connected by wireless communication.

Note that the term “optical system” used herein is used in a broad sense. That is, the analysis optical system 7 is defined as a system including a light source, an imaging element, and the like in addition to an optical element such as a lens. The same applies to the observation optical system 9 in the observation unit 63.

Specifically, the analysis optical system 7 includes an electromagnetic wave emitter 71, an output adjuster 72, a half mirror 73, a reflective object lens 74, a dichroic mirror 75, a first parabolic mirror 76A, a first detector 77A, a first beam splitter 78A, a second parabolic mirror 76B, a second detector 77B, a second beam splitter 78B, an LED light source 79, an imaging lens 80, a first camera 81, and an optical element 82 as illustrated in FIG. 7. The reflective object lens 74 is an example of a “second objective lens” in the present embodiment. Further, the first detector 77A and the second detector 77B are examples of a “detector” in the present embodiment. Some of the constituent elements of the analysis optical system 7 are also illustrated in FIG. 6.

The electromagnetic wave emitter 71 emits an electromagnetic wave for analysis of the sample SP. In particular, the electromagnetic wave emitter 71 according to the present embodiment includes a laser light source that emits laser light as the electromagnetic wave.

Although not illustrated in detail, the electromagnetic wave emitter 71 according to the present embodiment includes: an excitation light source configured using a laser diode (LD) or the like; a focusing lens that collects laser output from the excitation light source and emits the laser as laser excitation light; a laser medium that generates a fundamental wave based on the laser excitation light; a Q switch configured to pulse-oscillate the fundamental wave; a rear mirror and an output mirror configured to amplify the fundamental wave; and a wavelength conversion element that converts a wavelength of laser light output from the output mirror.

Here, as the laser medium, for example, rod-shaped Nd:YAG is preferably used in order to obtain high energy per pulse. Note that, in the present embodiment, a wavelength (so-called fundamental wavelength) of photons emitted from the laser medium by stimulated emission is set to 1064 nm in the infrared range.

Further, as the Q switch, a passive Q switch in which a transmittance increases when an intensity of a fundamental wave exceeds a predetermined threshold can be used, instead of a so-called active Q switch in which an attenuation rate can be controlled from the outside. The passive Q switch is configured using, for example, a supersaturated absorber such as Cr:YAG. Since the passive Q switch is used, it is possible to automatically perform pulse oscillation at a timing when a predetermined amount of energy or more is accumulated in the laser medium.

Further, two nonlinear optical crystals, such as LBO (LiB₃O₃), are used as the wavelength conversion element. Since two crystals are used, a third harmonic wave can be generated from the fundamental wave. A wavelength of the third harmonic wave is set to 355 nm in the ultraviolet region in the present embodiment.

That is, the electromagnetic wave emitter 71 according to the present embodiment can output the laser light formed of ultraviolet rays as the electromagnetic wave. As a result, it is possible to optically analyze the transparent sample SP like glass by LIBS. Further, the proportion of laser light in the ultraviolet range reaching a human retina is extremely small. The safety of the device can be enhanced by adopting the configuration in which the laser light does not form an image on the retina.

The output adjuster 72 is arranged on an optical path connecting the electromagnetic wave emitter 71 and the half mirror 73, and can adjust an output (hereinafter, also referred to as “laser power”) of the electromagnetic wave (laser light). Specifically, the output adjuster 72 according to the present embodiment includes a half-wave plate 72a and a deflection beam splitter 72b. The half-wave plate 72a is configured to rotate relative to the deflection beam splitter 72b, and the amount of light passing through the deflection beam splitter 72b can be adjusted by controlling a rotation angle thereof.

The half mirror 73 is laid out so as to reflect the laser light output from the electromagnetic wave emitter 71 and passing through the output adjuster 72 and guide the laser light to the sample SP via the reflective object lens 74, and to transmit light (light emitted due to plasma generated on the surface of the sample SP) returning from the sample SP in response to the laser light and guide the light to the first detector 77A, the second detector 77B, and the first camera 81.

The reflective object lens 74 collects the electromagnetic wave from the sample SP corresponding to the irradiation of the electromagnetic wave (laser light). Specifically, the reflective object lens 74 according to the present embodiment has the analysis optical axis Aa extending along the substantially vertical direction, collects the electromagnetic wave emitted from the electromagnetic wave emitter 71 to irradiate the sample SP with the collected electromagnetic wave, and collects the plasma light (light emitted due to the plasma formation generated on the surface of the sample SP) returning from the sample SP corresponding to the electromagnetic wave (laser light) applied to the sample SP. The analysis optical axis Aa is provided to be parallel to the observation optical axis Ao of an objective lens 92 of the observation unit 63. The analysis optical axis Aa is an example of an “optical axis of the second objective lens” in the present embodiment.

The reflective object lens 74 is configured such that an optical system related to light reception by the first camera 81, an optical system related to the laser light output from the electromagnetic wave emitter 71 and emitted to the sample SP, and an optical system related to the light returning from the sample SP and reaching the first and second detectors 77A and 77B are coaxial. In other words, the reflective object lens 74 is shared by the three types of optical systems.

Specifically, the reflective object lens 74 according to the present embodiment is a Schwarzschild objective lens including two mirrors, and incorporates a primary mirror 74a having an annular shape and a relatively large diameter and a secondary mirror 74b having a disk shape and a relatively small diameter.

The primary mirror 74a allows the laser light to pass through an opening provided in a center thereof, and reflects the light returning from the sample SP (electromagnetic waves emitted from electrons when returning from a plasma state to a gas state or the like) by a mirror surface provided around the opening. The latter reflection light is reflected again by a mirror surface of the secondary mirror 74b, and passes through the opening of the primary mirror 74a in a state of being coaxial with the laser light.

The secondary mirror 74b is configured to transmit the laser light and collect and reflect the light reflected by the primary mirror 74a. The former laser light is applied to the sample SP, but the latter reflection light passes through the opening of the primary mirror 74a and reaches the half mirror 73 as described above. The reflection light having reached the half mirror 73 passes through the half mirror 73 and reaches the dichroic mirror 75.

When laser light is input to the reflective object lens 74, the laser light passes through the secondary mirror 74b arranged at the center of the reflective object lens 74 and reaches the surface of the sample SP. When the sample SP is locally turned into plasma by the laser light so that light is emitted, the light passes through an opening provided around the secondary mirror 74b and reaches the primary mirror 74a. The light that has reached the primary mirror 74a is reflected by the mirror surface to reach the secondary mirror 74b, and is reflected by the secondary mirror 74b to return from the reflective object lens 74 to the half mirror 73.

The dichroic mirror 75 guides a part of the light returning from the sample SP to the first detector 77A, and guides the other part to the second detector 77B or the like. Specifically, the light returning from the sample SP includes various wavelength components in addition to a wavelength of the laser light. Therefore, the dichroic mirror 75 according to the present embodiment reflects light in a short wavelength band out of the light returning from the sample SP and guides the light to the first detector 77A. The dichroic mirror 75 also transmits light in the other bands and guides the light to the second detector 77B.

The first parabolic mirror 76A is configured as a so-called parabolic mirror, and is arranged between the dichroic mirror 75 and the first detector 77A. The first parabolic mirror 76A collects light reflected by the dichroic mirror 75 and causes the collected light to be incident on the first detector 77A.

The first detector 77A generates an intensity distribution spectrum which is an intensity distribution for each wavelength of the electromagnetic wave (light returning from the sample SP) generated in the sample SP and collected by the reflective object lens 74. The first detector 77A reflects light at an angle different for each wavelength to separate the light, and causes each beam of the separated light to be incident on the imaging element having a plurality of pixels. As a result, a wavelength of an electromagnetic wave (light) received by each pixel can be made different, and a light reception intensity can be acquired for each wavelength. As the first detector 77A, for example, a detector based on a Czerny-Turner detector can be used. An entrance slit of the first detector 77A is aligned with a focal position of the first parabolic mirror 76A. The intensity distribution spectrum generated by the first detector 77A is input to the controller 21 of the controller main body 2.

The first beam splitter 78A reflects a part of light transmitted through the dichroic mirror 75 to be guided to the second detector 77B, and transmits the other part to be guided to the second beam splitter 78B.

The second parabolic mirror 76B is configured as a parabolic mirror similarly to the first parabolic mirror 76A, and is arranged between the first beam splitter 78A and the second detector 77B. The second parabolic mirror 76B collects light reflected by the first beam splitter 78A and causes the collected light to be incident on the second detector 77B.

The second detector 77B generates an intensity distribution spectrum which is an intensity distribution for each wavelength of the electromagnetic wave (light returning from the sample SP) generated in the sample SP and collected by the reflective object lens 74, which is similar to the first detector 77A. As the second detector 77B, for example, a detector based on a Czerny-Turner detector can be used. An entrance slit of the second detector 77B is aligned with a focal position of the second parabolic mirror 76B. The intensity distribution spectrum generated by the second detector 77B is input to the controller 21 illustrated in FIG. 1 and the like, which is similar to the first detector 77A.

The second beam splitter 78B transmits at least a part of light, which has been transmitted through the first beam splitter 78A, to be incident on the first camera 81 via the imaging lens 80. The second beam splitter 78B also reflects illumination light, which has been emitted from the LED light source 79 and passed through the optical element 82, to be emitted to the sample SP via the first beam splitter 78A, the dichroic mirror 75, the half mirror 73, and the reflective object lens 74.

Note that the illumination light emitted from the LED light source 79 is coaxial with the laser light output from the electromagnetic wave emitter 71 and emitted to the sample SP, and functions as a so-called “coaxial epi-illuminator”. Although the LED light source 79 is incorporated in the analysis housing 70 in the example illustrated in FIG. 7, the present disclosure is not limited to such a configuration. For example, a light source may be laid out outside the analysis housing 70, and the light source and the analysis optical system 7 may be coupled to the optical system via an optical fiber cable.

The first camera 81 detects a light reception amount of light from the sample SP received through the reflective object lens 74 to capture an image of the sample SP. Specifically, the first camera 81 according to the present embodiment photoelectrically converts light incident through the imaging lens 80 by a plurality of pixels arranged on a light receiving surface thereof, and converts the light into an electrical signal corresponding to an optical image of a subject (the sample SP).

The first camera 81 may have a plurality of light receiving elements arranged along the light receiving surface. In this case, each of the light receiving elements corresponds to a pixel so that an electrical signal based on the light reception amount in each of the light receiving elements can be generated. Specifically, the first camera 81 according to the present embodiment is configured using an image sensor including a complementary metal oxide semiconductor (CMOS), but is not limited to this configuration. As the first camera 81, for example, an image sensor including a charged-coupled device (CCD) can also be used.

Then, the first camera 81 generates image data corresponding to the optical image of the subject based on the electrical signal generated by detecting the light reception amount in each of the light receiving elements, and inputs the image data to the controller main body 2.

Note that the light returning from the sample SP is incident while being divided into the first detector 77A, the second detector 77B, and the first camera 81. Therefore, the light reception amount in the first camera 81 is smaller than that of a second camera 93 which will be described later.

The optical components that have been described so far are accommodated in the analysis housing 70. A through-hole 70a is provided in a lower surface of the analysis housing 70. The reflective object lens 74 faces the placement surface 51a via the through-hole 70a.

A shielding member 83 illustrated in FIG. 7 is arranged in the analysis housing 70. The shielding member 83 is arranged between the through-hole 70a and the reflective object lens 74, and can be inserted on an optical path of laser light based on an electrical signal input from the controller main body 2 (see the dotted line in FIG. 7). The shielding member 83 is configured not to transmit at least the laser light.

The emission of laser light from the analysis housing 70 can be restricted by inserting the shielding member 83 on the optical path. The shielding member 83 may be arranged between the electromagnetic wave emitter 71 and the output adjuster 72.

As illustrated in FIG. 10, the analysis housing 70 also defines an accommodation space of the unit switching mechanism 65 in addition to an accommodation space of the analysis optical system 7. In such a sense, the analysis housing 70 can also be regarded as an element of the unit switching mechanism 65.

Specifically, the analysis housing 70 according to the present embodiment is formed in a box shape in which a dimension in the front-rear direction is shorter than a dimension in the left-right direction. Then, a left side portion of a front surface 70b of the analysis housing 70 protrudes forward so as to secure a movement margin of the guide rail 65a in the front-rear direction. Hereinafter, such a protruding portion is referred to as a “protrusion”, and is denoted by reference sign 70c. The protrusion 70c is arranged at a lower half of the front surface 70b in the vertical direction (in other words, only a lower half of the left side portion of the front surface 70b protrudes).

—Basic Principle of Analysis by Analysis Unit 62—

The controller 21 executes component analysis of the sample SP based on the intensity distribution spectra input from the first detector 77A and the second detector 77B as detectors. As a specific analysis method, the LIBS method can be used as described above. The LIBS method is a method for analyzing a component contained in the sample SP at an element level (so-called elemental analysis method).

Generally, when high energy is applied to a substance, an electron is separated from an atomic nucleus, so that the substance is turned into a plasma state. The electron separated from the atomic nucleus temporarily becomes a high-energy and unstable state, but loses energy from such a state and is captured again by the atomic nucleus to transition to a low-energy and stable state (in other words, returns from the plasma state to a non-plasma state).

Here, the energy lost from the electron is emitted from the electron as the electromagnetic wave, but the magnitude of the energy of the electromagnetic wave is defined by an energy level based on a shell structure unique to each element. That is, the energy of the electromagnetic wave emitted when the electron returns from the plasma to the non-plasma state has a unique value for each element (more precisely, a trajectory of the electron bound to the atomic nucleus). The magnitude of energy of an electromagnetic wave is defined by a wavelength of the electromagnetic wave. Therefore, by analyzing a wavelength distribution of the electromagnetic wave emitted from the electron, that is, a wavelength distribution of the electromagnetic wave (light) emitted from the substance at the time of the plasma state, the components contained in the substance can be analyzed at the element level. Such a technique is generally called an atomic emission spectroscopy (AES) method.

The LIBS method is an analysis method belonging to the AES method. Specifically, in the LIBS method, the substance (sample SP) is irradiated with laser to apply energy to the substance. Here, a site irradiated with the laser is locally turned into plasma, and thus, component analysis of the substance can be performed by analyzing the intensity distribution spectrum of light emitted with the turning into plasma.

That is, as described above, the wavelength of each light (electromagnetic wave) has the unique value for each element, and thus, an element corresponding to a peak becomes a component of the sample SP when the intensity distribution spectrum forms the peak at a specific wavelength. Then, when the intensity distribution spectrum includes a plurality of peaks, a component ratio of each element can be calculated by comparing the intensity (light reception amount) of each of the peaks.

According to the LIBS method, vacuuming is unnecessary, and component analysis can be performed in the atmospheric open state. Further, although the sample SP is subjected to a destructive test, it is unnecessary to perform a treatment such as dissolving the entire sample SP so that position information of the sample SP remains (the test is only locally destructive).

—Observation Unit 63—

The observation unit 63 is configured as a tubular digital microscope, and includes the observation optical system 9 configured to observe the sample SP and a lens barrel 90 accommodating the observation optical system 9. The observation optical system 9 is a set of components related to observation of the sample SP, and at least some of the respective components are accommodated in the lens barrel 90. Here, the lens barrel 90 refers to a tubular housing at a distal end around the objective lens 92 out of the entire housing of the observation unit 63. The lens barrel 90 can be detached alone from the observation unit 63.

A communication cable C2 configured to transmit and receive an electrical signal to and from the controller main body 2 and an optical fiber cable C3 configured to guide illumination light from the outside are connected to the observation unit 63. Note that the communication cable C2 is not essential, and the observation unit 63 and the controller main body 2 may be connected by wireless communication.

Specifically, the observation optical system 9 includes a mirror group 91, the objective lens 92, and the second camera 93 as illustrated in FIG. 6. The objective lens 92 is an example of a “first objective lens” in the present embodiment. Further, the second camera 93 is an example of a “camera” in the present embodiment.

The mirror group 91 reflects the illumination light guided from the optical fiber cable C3 to be guided to the surface of the sample SP via the objective lens 92. The illumination light is coaxial with the observation optical axis Ao of the objective lens 92, and functions as a so-called “coaxial epi-illuminator”. Note that a light source may be incorporated in the lens barrel 90, instead of guiding the illumination light from the outside through the optical fiber cable C3. In that case, the optical fiber cable C3 is unnecessary.

The mirror group 91 also transmits reflection light from the sample SP and guides the reflection light to the second camera 93. The mirror group 91 according to the present embodiment can be configured using a total reflection mirror, a half mirror, or the like as illustrated in FIG. 6.

The objective lens 92 has the observation optical axis Ao extending along the substantially vertical direction, collects illumination light to be emitted to the sample SP placed on the placement stage 51, and collects light (reflection light) from the sample SP. The observation optical axis Ao is provided to be parallel to the analysis optical axis Aa of the reflective object lens 74 of the observation unit 63. The observation optical axis Ao is an example of an “optical axis of the first objective lens” in the present embodiment.

Further, a ring illuminator 92a is mounted on the objective lens 92, and the ring illuminator 92a can be used as an illuminator for observation (non-coaxial epi-illuminator) as schematically illustrated in FIG. 6 although details are omitted.

Further, the objective lens 92 is detachably attached to lens barrel 90. As a result, the magnification of the observation optical system 9 can be changed without replacing the observation unit 63 together with the lens barrel 90.

The second camera 93 detects a light reception amount of light (reflection light) from the sample SP received through the objective lens 92 to capture an image of the sample SP. Specifically, the second camera 93 according to the present embodiment photoelectrically converts light incident from the sample SP through the objective lens 92 by a plurality of pixels arranged on a light receiving surface thereof, and converts the light into an electrical signal corresponding to an optical image of the subject (sample SP).

The second camera 93 may have a plurality of light receiving elements arranged along the light receiving surface. In this case, each of the light receiving elements corresponds to a pixel so that an electrical signal based on the light reception amount in each of the light receiving elements can be generated. The second camera 93 according to the present embodiment includes an image sensor including a CMOS similarly to the first camera 81, but an image sensor including a CCD can also be used.

Then, the second camera 93 generates image data corresponding to the optical image of the subject based on the electrical signal generated by detecting the light reception amount in each of the light receiving elements, and inputs the image data to the controller main body 2.

Note that the light returning from the sample SP is incident on the second camera 93 without being divided into a detector and the like. Therefore, the light reception amount in the second camera 93 is larger than the light reception amount in the first camera 81. The second camera 93 can generate an image brighter than that of the first camera 81.

The lens barrel 90 is formed in a substantially cylindrical shape as illustrated in FIG. 3 and the like. The longitudinal direction of the lens barrel 90 coincides with a direction in which the observation optical axis Ao extends. As illustrated in FIG. 3, a dimension of the lens barrel 90 in the front-rear direction is shorter than the dimension of the analysis housing 70 in the front-rear direction. Further, a dimension of the lens barrel 90 in the left-right direction is shorter than the dimension of analysis housing 70 in the left-right direction as illustrated in FIG. 4.

In this manner, the lens barrel 90 is formed to be more compact than the analysis housing 70. Further, the analysis housing 70 also accommodates optical components not included in the observation optical system 9, such as the first detector 77A and the second detector 77B as the detectors. Due to such circumstances, the observation unit 63 is formed to be lighter than the analysis unit 62.

—Unit Coupler 64—

The unit coupler 64 is a member configured to couple the observation unit 63 with the analysis unit 62. The unit coupler 64 couples both the units 62 and 63, so that the analysis optical system 7 and the observation optical system 9 move integrally. The unit coupler 64 is an example of a “lens barrel holder” in the present embodiment.

The unit coupler 64 can be attached inside and outside the analysis housing 70, that is, to the inside or outside the analysis housing 70, or to the stand 4. In particular, the unit coupler 64 is attached to an outer surface of the analysis housing 70 in the present embodiment.

Specifically, the unit coupler 64 according to the present embodiment is configured to be attachable to the protrusion 70c of the analysis housing 70 and to hold the lens barrel 90 on the right side of the protrusion 70c.

Specifically, the unit coupler 64 includes a fixing section 64a fastened to an upper surface of the protrusion 70c, an arm 64b extending downward from the fixing section 64a, and a holder 64c extending rightward from the arm 64b and configured to be capable of holding the lens barrel 90 as illustrated in FIG. 8.

Among them, the fixing section 64a is formed in a flat plate shape extending along the horizontal direction. As a fastening tool (not illustrated) is inserted from above in a state where the fixing section 64a is in close contact with the upper surface of the protrusion 70c, it is possible to fix the unit coupler 64 to the analysis housing 70, and eventually, the analysis unit 62.

The arm 64b is formed in a long plate shape in which a dimension in the vertical direction is longer than a dimension in the front-rear direction. Since the fixing section 64a is fastened to the protrusion 70c, a left side surface of the arm 64b and a right side surface of the protrusion 70c come into contact with each other, and the lens barrel 90 can be stably positioned without being wobbled as illustrated in FIG. 4.

The holder 64c is formed in a flat plate shape extending along the horizontal direction and having a through-hole 64d. An inner diameter of the through-hole 64d substantially coincides with an outer diameter of the lens barrel 90. An outer surface of the holder 64c is provided with: a first screw 64e configured to adjust a rotation angle of the lens barrel 90 about the observation optical axis Ao; a second screw 64f and a third screw 64g configured to adjust positioning of the lens barrel 90 in the horizontal direction; and a fourth screw 64h configured to fix the lens barrel 90 to the holder 64c after adjustment of the rotation angle and the positioning of the lens barrel 90.

Further, a front surface of the protrusion 70c protrudes forward from the unit coupler 64 and a front portion of the lens barrel 90 in a state where the lens barrel 90, and eventually, the observation unit 63 is held by the unit coupler 64 as illustrated in FIG. 3. In this manner, the lens barrel 90 and at least a part of the analysis housing 70 (the protrusion 70c in the present embodiment) are laid out so as to overlap each other when viewed from the side (when viewed from a direction orthogonal to the moving direction of the observation optical system 9 and the analysis optical system 7 by the unit switching mechanism 65 as the horizontal drive mechanism) in the state where the unit coupler 64 holds the lens barrel 90 in the present embodiment.

The unit coupler 64 according to the present embodiment can fix the relative position of the analysis optical axis Aa with respect to the observation optical axis Ao by fixing the lens barrel 90 to the analysis optical system 7.

Specifically, as illustrated in FIG. 10, the unit coupler 64 serving as the lens barrel holder holds the lens barrel 90, so that the observation optical axis Ao and the analysis optical axis Aa are arranged side by side along the direction (front-rear direction in the present embodiment) in which the observation optical system 9 and the analysis optical system 7 relatively move with respect to the stage 5 by the unit switching mechanism 65 as the horizontal drive mechanism. In particular, the observation optical axis Ao is arranged on the front side as compared with the analysis optical axis Aa in the present embodiment.

Further, as illustrated in FIG. 10, the observation optical axis Ao and the analysis optical axis Aa are arranged such that positions in a non-moving direction (the left-right direction in the present embodiment), which is a direction that extends along the horizontal direction and is orthogonal to the moving direction (the front-rear direction in the present embodiment), coincide with each other when the unit coupler 64 holds the lens barrel 90.

Further, the observation unit 63 can be appropriately replaced with respect to the analysis unit 62 as illustrated in FIG. 9. Therefore, the unit coupler 64 according to the present embodiment is configured to selectively hold any one of a plurality of types of lens barrels 90, 90′, and 90″ accommodating mutually different observation optical systems 9, 9′, and 9″ (alternatively, each of a plurality of types of observation units 63, 63′, and 63″ accommodating mutually different observation optical systems 9, 9′, and 9″). Here, the different observation optical systems 9′ and 9″ refer to optical systems in which the magnification of the objective lens 92, the presence or absence of the ring illuminator 92a, and the like are different.

Note that, at the time of replacing the lens barrel 90, the lens barrel 90 may be replaced together with the unit coupler 64. Alternatively, the lens barrel 90 may be removed from the unit coupler 64, and only the lens barrel 90 may be replaced with the other lens barrel 90′ or 90″. At the time of replacing the lens barrel 90, the lens barrel is replaced together with the unit coupler 64, so that a working distance (WD) between the sample SP (observation target) and the objective lens 92 can be made consistent (working distance can be kept constant) before and after the replacement of the lens barrel 90.

Specifically, the unit coupler 64 to which the lens barrel 90 having a short working distance (WD) is attached is designed such that, for example, a distance between the sample SP and the lens barrel 90 becomes short by lengthening the arm 64b.

Further, the unit coupler 64 to which the lens barrel 90 having a long working distance (WD) is attached is designed such that a distance between the sample SP and the lens barrel 90 becomes long by shortening the arm 64b, for example.

In any design, when the working distance (WD) between the sample SP and the objective lens 92 is made consistent before and after the replacement of the lens barrel 90 by using the length of the arm 64b (when the working distance is kept constant), it is desirable to adopt a design such that the sum of the working distance (WD) of the lens barrel 90 and the length of the arm 64b is constant.

Note that the working distance (WD) between the sample SP and the objective lens 92 may be made consistent before and after the replacement of the lens barrel 90 by adjusting dimensions of various sites such as a thickness of the holder 64c, instead of the length of the arm 64b.

Each of the lens barrels 90, 90′, and 90″ is configured to be capable of identifying at least a type of the objective lens 92. A lens sensor Sw1 configured to detect such a type is attached to each of the lens barrels 90, 90′, and 90″. When the lens barrel 90 is attached to the observation optical system 9, the lens sensor Sw1 can detect at least a type of the objective lens 92 among types of the observation optical system 9 corresponding to the lens barrel 90 fixed to the analysis optical system 7 by the unit coupler 64. A detection signal of the lens sensor Sw1 is input to the controller main body 2.

Note that a signal input to the controller main body 2 may include not only the detection signal of the lens sensor Sw1 but also, for example, a signal indicating the magnification of the lens barrel 90 attached to the observation optical system 9.

As the lens barrel 90 is attached to the observation optical system 9, the controller main body 2 and the lens barrel 90 are electrically connected. Through this connection, the controller main body 2 may acquire the type of the objective lens 92, the magnification of lens barrel 90, and the like. Note that it is also possible to adopt a configuration in which the type of the observation optical system 9, the magnification of the lens barrel 90, and the like are manually input to the controller main body 2 via the operation section 3 and the like, instead of attaching the lens sensor Sw1 to the optical system unit group 1.

Further, the controller main body 2 may drive the head drive 47 according to the type of the lens barrel 90 attached to the observation optical system 9 to move the head 6 in the Z-axis direction. The controller main body 2 may identify the type of the objective lens 92 by the detection signal of the lens sensor Sw1 to acquire the working distance (WD) of the objective lens 92 fixed by the unit coupler 64, for example, and drive the head drive 47 such that the working distance (WD) between the sample SP, which is an example of the observation target, and the objective lens 92 is consistent before and after the replacement of the lens barrel 90 according to the acquired working distance (WD).

Note that the attachment of the plurality of types of lens barrels 90, 90′, and 90″ accommodating the mutually different observation optical systems 9, 9′, and 9″ has been described herein, but this description is commonly applied not only to the lens barrels 90, 90′, and 90″ but also to a case of collectively attaching the entire observation unit 63.

In this case, the terms of the “plurality of types of lens barrels 90, 90′, and 90″” and the “lens barrel 90″ in the above description may be read as the terms of the “plurality of types of observation units 63, 63′, and 63″” and the “observation unit 63”, respectively (see also FIG. 9). In this case, the unit coupler 64 in the state of holding the observation unit 63 is arranged outside the analysis housing 70, for example, as illustrated in FIG. 9.

—Unit Switching Mechanism 65—

The unit switching mechanism 65 is configured to move the relative positions of the observation optical system 9 and the analysis optical system 7 with respect to the placement stage 51 along the horizontal direction such that the capturing of the sample SP by the observation optical system 9 and the irradiation of the electromagnetic wave (laser light) (in other words, the irradiation of the electromagnetic wave by the electromagnetic wave emitter 71 of the analysis optical system 7) in the case of generating the intensity distribution spectrum by the analysis optical system 7 can be performed on the identical point in the sample SP as the observation target. The unit switching mechanism 65 is an example of the “horizontal drive mechanism” in the present embodiment.

The moving direction of the relative position by the unit switching mechanism 65 can be a direction in which the observation optical axis Ao and the analysis optical axis As are arranged. As illustrated in FIG. 10, the unit switching mechanism 65 according to the present embodiment moves the relative positions of the observation optical system 9 and the analysis optical system 7 with respect to the placement stage 51 along the front-rear direction.

The unit switching mechanism 65 according to the present embodiment relatively displaces the analysis housing 70 with respect to the stand 4 and the attachment plate 61. Since the analysis housing 70 and the lens barrel 90 are coupled by the unit coupler 64, the lens barrel 90 is also integrally displaced by displacing the analysis housing 70.

Specifically, the unit switching mechanism 65 according to the present embodiment includes the guide rail 65a and an actuator 65b, and the guide rail 65a is formed to protrude forward from a front surface of the attachment plate 61.

Specifically, a proximal end of the guide rail 65a is fixed to the attachment plate 61. On the other hand, a distal side portion of the guide rail 65a is inserted into an accommodation space defined in the analysis housing 70, and is attached to the analysis housing 70 in an insertable and removable state. An insertion and removal direction of the analysis housing 70 with respect to the guide rail 65a is equal to a direction (the front-rear direction in the present embodiment) in which the attachment plate 61 and the analysis housing 70 are separated or brought close to each other.

The actuator 65b can be configured using, for example, a linear motor or a stepping motor that operates based on an electrical signal from the controller 100. It is possible to relatively displace the analysis housing 70, and eventually, the observation optical system 9 and the analysis optical system 7 with respect to the stand 4 and the attachment plate 61 by driving the actuator 65b. When the stepping motor is used as the actuator 65b, a motion conversion mechanism that converts a rotational motion of an output shaft in the stepping motor into a linear motion in the front-rear direction is further provided.

The unit switching mechanism 65 further includes a movement amount sensor Sw2 configured to detect each movement amount of the observation optical system 9 and the analysis optical system 7. The movement amount sensor Sw2 can be configured using, for example, a linear scale (linear encoder) or the like.

The movement amount sensor Sw2 detects a relative distance between the analysis housing 70 and the attachment plate 61, and inputs an electrical signal corresponding to the relative distance to the controller main body 2. The controller main body 2 calculates the amount of change in the relative distance input from the movement amount sensor Sw2 to determine each displacement amount of the observation optical system 9 and the analysis optical system 7.

When the unit switching mechanism 65 as the horizontal drive mechanism is operated, the head 6 slides along the horizontal direction, and the relative positions of the observation optical system 9 and the analysis optical system 7 with respect to the placement stage 51 move (horizontally move) as illustrated in FIGS. 11A and 11B. This horizontal movement causes the head 6 to switch between a first mode in which the objective lens 92 faces the sample SP and a second mode in which the reflective object lens 74 faces the sample SP.

As illustrated in FIGS. 11A and 11B, the head 6 is in a relatively retracted state in the first mode, and the head 6 is in a relatively advanced state in the second mode. The first mode is an operation mode for performing magnifying observation of the sample SP by the observation optical system 9, and the second mode is an operation mode for performing component analysis of the sample SP by the analysis optical system 7.

In particular, the analysis and observation device A according to the present embodiment is configured such that a point to which the objective lens 92 is directed in the first mode and a point to which the reflective object lens 74 is directed in the second mode are the same point. Specifically, the analysis and observation device A is configured such that a point where the observation optical axis Ao intersects with the sample SP in the first mode and a point where the analysis optical axis Aa intersects with the sample SP in the second mode are the same (see FIG. 11B).

In order to implement such a configuration, a movement amount D2 of the head 6 when the unit switching mechanism 65 is operated is set to be the same as a distance D1 between the observation optical axis Ao and the analysis optical axis Ao (see FIGS. 10 and 11A). In addition, the arrangement direction of the observation optical axis Ao and the analysis optical axis Ao is set to be parallel to a moving direction of the head 6 as illustrated in FIG. 10.

With the above configuration, the image generation of the sample SP by the observation optical system 9 and the generation of the intensity distribution spectrum by the analysis optical system 7 (specifically, the irradiation of the electromagnetic wave by the analysis optical system 7 when the intensity distribution spectrum is generated by the analysis optical system 7) can be executed on the same point in the sample SP from the same direction at timings before and after performing the switching between the first mode and the second mode.

Further, the cover member 61b in the attachment plate 61 is arranged so as to cover the reflective object lens 74 forming the analysis optical system 7 (shielding state) in the first mode in which the head 6 is in the relatively retracted state, and is arranged so as to be separated from the reflective object lens 74 (non-shieling state) in the second mode in which the head 6 is in the relatively advanced state as illustrated in FIG. 11B.

In the former shielding state, laser light can be shielded by the cover member 61b even if the laser light is unintentionally emitted. As a result, the safety of the device can be improved.

Further, the connector 61c attached to the cover member 61b is electrically connected to the analysis housing 70 in the first mode (shielding state), and is electrically disconnected from the analysis housing 70 in the second mode (non-shielding state) as illustrated in FIG. 11B.

The connector 61c is configured to allow the emission of laser light from the electromagnetic wave emitter 71 in the state of being connected to the analysis housing 70, and allow the emission of laser light from the electromagnetic wave emitter 71 according to an operation status of the tilting mechanism 45 in the state of being disconnected from the analysis housing 70 (in other words, the emission of the laser light is restricted depending on the operation status of the tilting mechanism 45). With this configuration, unintended emission of the laser light can be suppressed, and the safety of the device can be further improved.

(Further Details of Tilting Mechanism 45) FIGS. 12A and 12B are views for describing an operation of the tilting mechanism 45. Hereinafter, the tilting mechanism 45, such as a relation with the unit coupler 64, will be further described with reference to FIGS. 12A and 12B.

The tilting mechanism 45 is a mechanism including the above-described shaft member 44 and the like, and can tilt at least the observation optical system 9 of the analysis optical system 7 and the observation optical system 9 with respect to the reference axis As perpendicular to the placement surface 51a.

As described above, the unit coupler 64 integrally couples the analysis unit 62 and the observation unit 63 such that the relative position of the observation optical axis Ao with respect to the analysis optical axis Aa is maintained in the present embodiment. Therefore, when the observation optical system 9 having the observation optical axis Ao is tilted, the analysis optical system 7 having the analysis optical axis Aa is tilted integrally with the observation optical system 9 as illustrated in FIGS. 12A and 12B.

In this manner, the tilting mechanism 45 according to the present embodiment integrally tilts the analysis optical system 7 and the observation optical system 9 while maintaining the relative position of the observation optical axis Ao with respect to the analysis optical axis Aa.

Further, an operation of the unit switching mechanism 65 as the horizontal drive mechanism and the operation of the tilting mechanism 45 are independent from each other, and a combination of both the operations is allowed. Therefore, the unit switching mechanism 65 as the horizontal drive mechanism can move the relative positions of the observation optical system 9 and the analysis optical system 7 in a state where at least the observation optical system 9 is held in a tilted posture by the tilting mechanism 45. That is, the analysis and observation device A according to the present embodiment can slide the head 6 back and forth in a state where the observation optical system 9 is tilted as indicated by the double-headed arrow A1 in FIG. 12B.

In particular, since the analysis optical system 7 and the observation optical system 9 are configured to be tilted integrally in the present embodiment, the unit switching mechanism 65 moves the relative positions of the observation optical system 9 and the analysis optical system 7 while maintaining the state where both the observation optical system 9 and the analysis optical system 7 are tilted by the tilting mechanism 45.

Further, the analysis and observation device A is configured to perform eucentric observation. That is, a three-dimensional coordinate system, which is unique to the device and is formed by three axes parallel to the X direction, the Y direction, and the Z direction, is defined in the analysis and observation device A. A storage device 21b of the controller 21 further stores a coordinate of an intersection position, which will be described later, in the three-dimensional coordinate system of the analysis and observation device A. The coordinate information of the intersection position may be stored in the storage device 21b in advance at the time of shipment of the analysis and observation device A from the factory. Further, the coordinate information of the intersection position stored in the storage device 21b may be updatable by a user of the analysis and observation device A.

The observation optical axis Ao, which is the optical axis of the objective lens 92, intersects with the central axis Ac. When the objective lens 92 swings about the central axis Ac, an angle (tilt θ) of the observation optical axis Ao with respect to the reference axis As changes while an intersection position between the observation optical axis Ao and the central axis Ac is maintained constant. In this manner, when the user swings the objective lens 92 about the central axis Ac by the tilting mechanism 45, a eucentric relation in which a visual field center of the second camera 93 does not move from the same observation target portion is maintained even if the objective lens 92 is in a tilted state, for example, in a case where an observation target portion of the sample SP is at the above-described intersection position. Therefore, it is possible to prevent the observation target portion of the sample SP from deviating from the visual field of the second camera 93 (visual field of the objective lens 92).

In particular, the analysis optical system 7 and the observation optical system 9 are configured to be tilted integrally in the present embodiment, and thus, the analysis optical axis Aa, which is the optical axis of the reflective object lens 74, intersects with the central axis Ac similarly to the observation optical axis Ao. When the reflective object lens 74 swings about the central axis Ac, an angle (tilt θ) of the analysis optical axis Aa with respect to the reference axis As changes while an intersection position between the analysis optical axis Ao and the central axis Ac is maintained constant.

Further, the tilting mechanism 45 can tilt the strut 42 rightward by about 90° or leftward by about 60° with respect to the reference axis As as described above. However, in the case where the analysis optical system 7 and the observation optical system 9 are configured to be integrally tilted, there is a possibility that laser light emitted from the analysis optical system 7 is emitted toward the user if the strut 42 is excessively tilted.

Therefore, assuming that the tilt of each of the observation optical axis Ao and the analysis optical axis Aa with respect to the reference axis As is 0, it is desirable that the tilt θ falls within a range satisfying a predetermined safety standard at least under a situation where laser light can be emitted. Specifically, the tilt θ can be adjusted within a range below a predetermined first threshold θmax in the present embodiment.

In order to keep the tilt θ below the first threshold θmax, a hard constraint may be imposed on the tilting mechanism 45, or a soft constraint may be imposed on the analysis optical system 7. The former constraint can be implemented by physically restricting an operation range of the tilting mechanism 45 by providing a brake mechanism (not illustrated) in the tilting mechanism 45.

On the other hand, when the latter constraint is imposed, the controller 21 can be configured to allow the emission of laser light from the electromagnetic wave emitter 71, which is a laser oscillator, or restrict the emission of laser light according to the tilt θ of the analysis optical system 7 with respect to the reference axis As. A laser controller 213 of the controller 21 controls the laser light according to the tilt.

(Other Hardware Configurations)

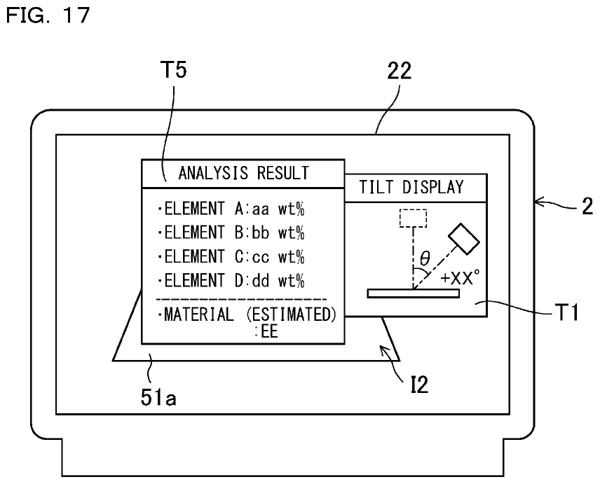

FIG. 17 is a perspective view illustrating a state where a shielding cover is attached to the head 6. As illustrated in FIG. 17, the analysis and observation device A according to the present embodiment further includes a shielding cover 10 attachable to the objective lens 92 or the analysis housing 70. The shielding cover 10 can surround at least the objective lens 92, which is the first objective lens, from the side and cover the objective lens 92. The shielding cover 10 can shield laser light in a state where the shielding cover 10 is attached to the objective lens 92 or the analysis housing 70. As a result, leakage of the laser light can be suppressed.

Further, the shielding cover 10 includes a connector (not illustrated). This connector is configured to be electrically connected to the objective lens 92 or the analysis housing 70 in a state where the shielding cover 10 is attached to the objective lens 92 or the analysis housing 70.

The analysis and observation device A according to the present embodiment is configured to generate a signal indicating whether or not the connector and the objective lens 92 or the analysis housing 70 are electrically connected, and input the signal to the controller 21. The controller 21, particularly the laser controller 213 to be described later, can execute control based on the signal as will be described later.

<Details of Controller Main Body 2>

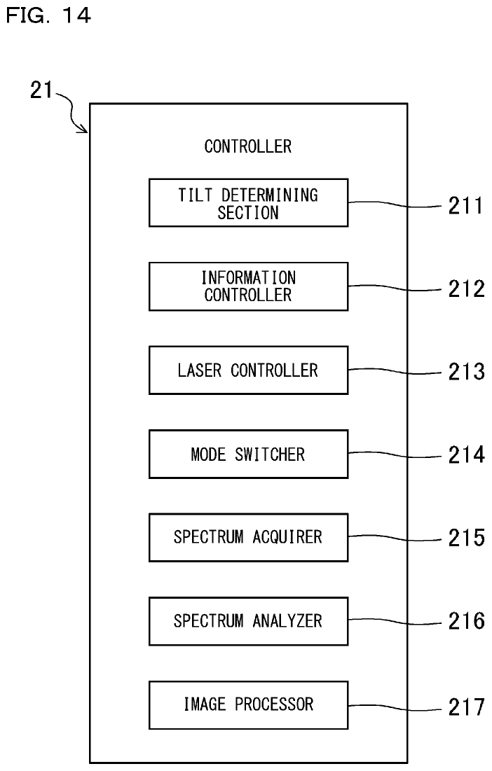

FIG. 13 is a block diagram illustrating a configuration of the controller main body 2. Further, FIG. 14 is a block diagram illustrating a configuration of the controller 21. In the example illustrated in FIG. 13, the controller main body 2 and the optical system unit group 1 are configured separately, but the configuration is not limited thereto. At least a part of the controller main body 2 may be provided in the optical system unit group 1.

As described above, the controller main body 2 according to the present embodiment includes the controller 21 that performs various processes and the display 22 that displays information related to the processes performed by the controller 21. Among them, the controller 21 includes: a processing device 21a including a CPU, a system LSI, a DSP, and the like; the storage device 21b including a volatile memory, a nonvolatile memory, and the like; and an input/output bus 21c.

The controller 21 is configured to be capable of executing both generation of image data of the sample SP based on the light reception amount of light from the sample SP and analysis of a substance contained in the sample SP based on an intensity distribution spectrum.

Specifically, the controller 21 is electrically connected with at least the mouse 31, the console 32, the keyboard 33, the head drive 47, the placement stage drive 53, the electromagnetic wave emitter 71, the output adjuster 72, the LED light source 79, the first camera 81, the shielding member 83, the ring illuminator 92a, the second camera 93, the actuator 65b, the lens sensor Sw1, the movement amount sensor Sw2, the first tilt sensor Sw3, and the second tilt sensor Sw4 as illustrated in FIG. 13.

The controller 21 electrically controls the head drive 47, the placement stage drive 53, the electromagnetic wave emitter 71, the output adjuster 72, the LED light source 79, the first camera 81, the shielding member 83, the ring illuminator 92a, the second camera 93, and the actuator 65b.

Further, output signals of the first camera 81, the second camera 93, the lens sensor Sw1, the movement amount sensor Sw2, the first tilt sensor Sw3, and the second tilt sensor Sw4 are input to the controller 21. The controller 21 executes calculation or the like based on the input output signal, and executes processing based on a result of the calculation.

For example, the controller 21 calculates the tilt θ of the analysis optical system 7 with respect to the reference axis As perpendicular to the placement surface 51a based on a detection signal of the first tilt sensor Sw3 and a detection signal of the second tilt sensor Sw4. When the tilt exceeds a predetermined threshold, the controller 21 notifies the user of a warning or the like.

Further, the controller 21 can identify at least a type of the objective lens 92 among types of the observation optical system 9 corresponding to the lens barrel 90 fixed to the analysis optical system 7 by the unit coupler 64 as the lens barrel holder, and can execute processing related to capturing of the sample SP based on a result of the identification. Here, the type of the objective lens 92 can be identified based on a detection signal of the lens sensor Sw1. The controller 21 can execute, for example, adjustment of exposure time of the second camera 93, adjustment of brightness of illumination light, and the like as the processing related to the capturing of the sample SP.

Specifically, the controller 21 according to the present embodiment includes a tilt determining section 211, an information controller 212, the laser controller 213, a mode switcher 214, a spectrum acquirer 215, and a spectrum analyzer 216 as illustrated in FIG. 14. These elements may be implemented by a logic circuit or may be implemented by executing software.

—Tilt Determining Section 211—

The tilt determining section 211 is electrically connected to the first tilt sensor Sw3 and the second tilt sensor Sw4, and receives detection signals from these sensors. The tilt determining section 211 calculates a difference between a tilt of the reference axis As with respect to the direction of gravity and a tilt of the analysis optical system 7 with respect to the direction of gravity (more specifically, a tilt of the analysis optical axis Aa with respect to the direction of gravity) based on the detection signals input from the respective sensors. This difference corresponds to the tilt θ of the analysis optical system 7 with respect to the reference axis As.

The tilt determining section 211 determines whether or not the tilt θ exceeds the first threshold θmax based on the calculated tilt θ. A result of the determination is input to the information controller 212 and the laser controller 213 together with the magnitude of the tilt θ.

—Information Controller 212—

The information controller 212 notifies the user regarding the emission of laser light based on the detection results of the first tilt sensor Sw3 and the second tilt sensor Sw4. The information controller 212 functions as a “notifier” in the present embodiment.

In the present embodiment, the information controller 212 is configured to use the display 22 as a notification medium. Instead of this configuration, a sound source (not illustrated) including a buzzer or the like can be used as the notification medium.

Specifically, the information controller 212 as the notifier switches a notification content to the user based on the determination result by the tilt determining section 211. The notification content includes at least a notification indicating that the emission of laser light is not recommended.

In particular, the information controller 212 according to the present embodiment displays a value of the tilt θ calculated by the tilt determining section 211 on the display 22, and at the same time, performs the notification to the user by appropriately changing a display mode on the display 22 according to the magnitude of the tilt θ.

Specifically, when the detected tilting is equal to or less than the first threshold θmax, the information controller 212 displays, on the display 22, a character string, a symbol, or the like indicating that the emission of laser light is permitted. Further, when the head 6 is set to the first mode, a transition may be made to a state where an operation input for starting switching from the first mode to the second mode by the mode switcher 214 can be received so as to form a state where laser light can be emitted.

On the other hand, when the detected tilt exceeds the first threshold θmax, the information controller 212 displays, on the display 22, a character string, a symbol, or the like indicating that the emission of laser light is not recommended. Further, when the head 6 is set to the first mode, a transition may be made to a state where an operation input for starting switching from the first mode to the second mode by the mode switcher 214 is not receivable so as to form a state where it is laser light is not emittable. Note that it is also possible to adopt a configuration in which laser light is forcibly emitted under an operation input by the user without forming the state where the laser light is not emittable.

The information controller 212 is also configured to be capable of changing a color of the character string, the symbol, or the like, which needs to be displayed on the display 22, or causing blinking of the character string, the symbol, or the like according to the determination result.

—Laser Controller 213—

The laser controller 213 controls whether or not to emit laser light from the analysis optical system 7 to the outside based on detection results of the first tilt sensor Sw3 and the second tilt sensor Sw4.

Specifically, when the tilt θ detected by the first tilt sensor Sw3 and the second tilt sensor Sw4 as the tilt detectors exceeds the first threshold θmax, the laser controller 213 according to the present embodiment restricts the emission of laser light via the shielding member 83 as an emission limiter In this case, the shielding member 83 operates as indicated by the dotted line in FIG. 7, the through-hole 70a of the analysis housing 70 is closed, and the emission of laser light to the outside of the analysis housing 70 is suppressed.

Here, the laser controller 213 allows the emission of the laser light regardless of the tilt θ of the analysis optical system 7 with respect to the reference axis As in the shielding state where the connector 61c and the analysis housing 70 are connected and the cover member 61b covers the reflective object lens 74. In this case, the safety of the device is secured without performing the control related to θ.

On the other hand, the laser controller 213 restricts the emission of laser light according to the tilt θ of the analysis optical system 7 with respect to the reference axis As in the non-shielding state where the connection between the connector 61c and the analysis housing 70 is released and the cover member 61b is separated from the reflective object lens 74. As a method for restricting the emission of laser light, the shielding member 83 may be operated as described above, or the electromagnetic wave emitter 71 may be set to a non-operating state.

Furthermore, the laser controller 213 can also perform control based on a connection status between the connector of the shielding cover 10 illustrated in FIG. 17 and the objective lens 92 or the analysis housing 70.

Specifically, the laser controller 213 determines that the shielding cover 10 is attached to the objective lens 92 or the analysis housing 70 when the connector is electrically connected to the objective lens 92 or the analysis housing 70, and determines that the shielding cover 10 is not attached to the objective lens 92 or the analysis housing 70 when the connector is not electrically connected to the objective lens 92 or the analysis housing 70.

Then, the laser controller 213 may be configured to allow the emission of laser light from the electromagnetic wave emitter 71 regardless of the tilt of the analysis optical system 7 with respect to the reference axis As when it is determined that the shielding cover 10 is attached to the objective lens 92 or the analysis housing 70, and to restrict the emission of laser light from the electromagnetic wave emitter 71 according to the tilt of the analysis optical system 7 with respect to the reference axis As when it is determined that the shielding cover 10 is not attached to the objective lens 92 or the analysis housing 70.

—Mode Switcher 214—

The mode switcher 214 switches from the first mode to the second mode or switches from the second mode to the first mode by advancing and retracting the analysis optical system 7 and the observation optical system 9 along the horizontal direction (the front-rear direction in the present embodiment).

Specifically, the mode switcher 214 according to the present embodiment reads, in advance, the distance D1 between the observation optical axis Ao and the analysis optical axis Ao stored in advance in the storage device 21b. Next, the mode switcher 214 operates the actuator 65b to advance and retract the analysis optical system 7 and the observation optical system 9.

Here, the mode switcher 214 compares each displacement amount of the observation optical system 9 and the analysis optical system 7 detected by the movement amount sensor Sw2 with the distance D1 read in advance, and determines whether or not the former displacement amount reaches the latter distance D1. Then, the advancement and retraction of the analysis optical system 7 and the observation optical system 9 are stopped at a timing when the displacement amount reaches the distance D1. Note that the distance D1 may be determined in advance, or the distance D1 and the maximum movable range of the actuator 65b may be configured to coincide with each other.

Note that the head 6 can be also tilted after switching to the second mode is performed by the mode switcher 214. In this case, the tilt determining section 211 detects the tilt θ or the information controller 212 performs various notifications in a state where the head 6 is set to the second mode as in the case of the first mode. In this manner, the tilting of the head 6, the determination of the tilt θ, and the notification based on the determination can be performed in at least one of the first mode and the second mode.

—Spectrum Acquirer 215—

The spectrum acquirer 215 emits laser light from the analysis optical system 7 in the second mode to acquire an intensity distribution spectrum. Specifically, the spectrum acquirer 215 according to the present embodiment emits the laser light (ultraviolet laser light) as an electromagnetic wave from the electromagnetic wave emitter 71, and irradiates the sample SP with the laser light via the reflective object lens 74. When the sample SP is irradiated with the laser light, a surface of the sample SP is locally turned into plasma, and light (electromagnetic wave) having energy corresponding to a width between energy levels is emitted from an electron when returning from the plasma state to a gas or the like. The light emitted in this manner returns to the analysis optical system 7 through the reflective object lens 74, and reaches the first camera 81, the first detector 77A, and the second detector 77B.

The light having returned to the first camera 81 generates image data obtained by capturing the light returning from the sample SP, and the light having returned to the first and second detectors 77A and 77B generates the intensity distribution spectrum as the spectrum acquirer 215 disperses the light reception amount for each wavelength. The intensity distribution spectrum generated by the spectrum acquirer 215 is input to the spectrum analyzer 216.

Note that the spectrum acquirer 215 synchronizes light reception timings of the first and second detectors 77A and 77B with an emission timing of the laser light. With this setting, the spectrum acquirer 215 can acquire the intensity distribution spectrum in accordance with the emission timing of the laser light.

—Spectrum Analyzer 216—

The spectrum analyzer 216 executes component analysis of the sample SP based on the intensity distribution spectrum generated by the spectrum analyzer 216. As described above, when the LIBS method is used, the surface of the sample SP is locally turned into plasma, and a peak wavelength of light emitted when returning from the plasma state to a gas or the like has a unique value for each element (more precisely, electron trajectory of an electron bound to an atomic nucleus). Therefore, it is possible to determine that an element corresponding to a peak position is a component contained in the sample SP by identifying the peak position of the intensity distribution spectrum, and it is also possible to determine component ratios of the respective elements and estimate the composition of the sample SP based on the determined component ratios by comparing magnitudes of peaks (heights of peaks).

An analysis result of the spectrum analyzer 216 can be displayed on the display 22 or stored in the storage device 21b in a predetermined format.

—Image Processor 217—

The image processor 217 can control a display mode on the display 22 based on image data (first image data I1 to be described later) generated by the second camera 93 in the observation optical system 9, image data (second image data I2 to be described later) generated by the first camera 81 in the analysis optical system 7, the analysis result by the spectrum analyzer 216, and the like.

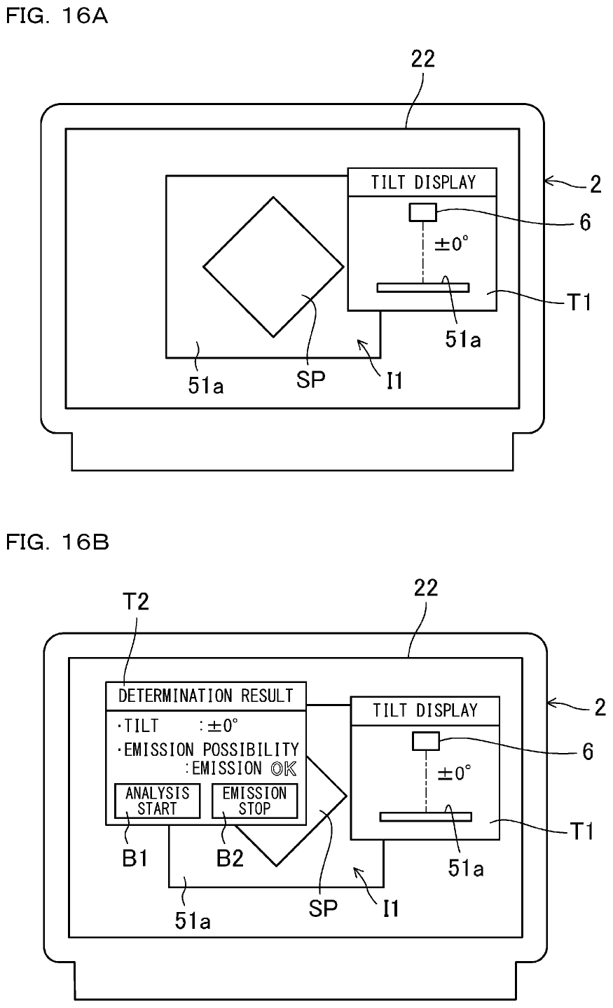

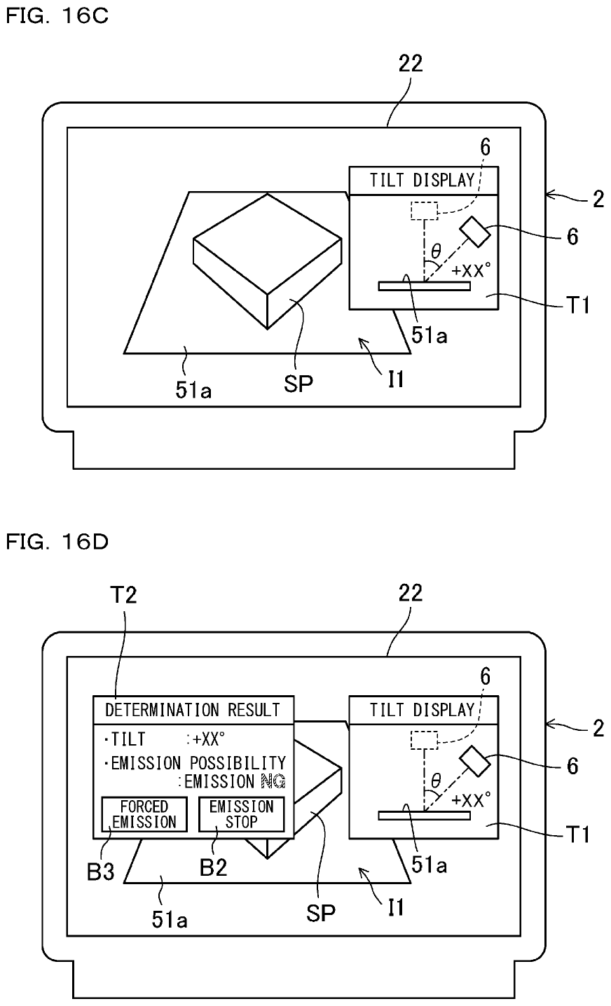

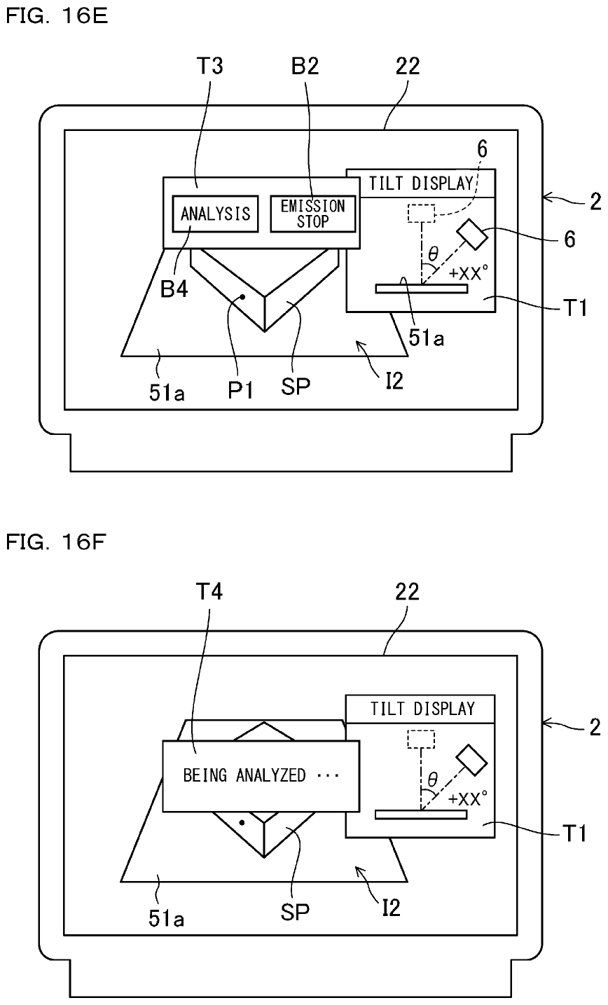

In particular, the image processor 217 according to the present embodiment causes a region, captured by the second camera 93 (for example, a center position of the region) and a region captured by the first camera 81 (for example, a center position of the region) to coincide before and after switching between the first mode and the second mode as illustrated in FIGS. 16C and 16E to be described later. The image processor 217 can adjust display modes of the first and second cameras 81 and 93, and eventually, the first and second image data I1 and I2 generated by the cameras 81 and 93, so as to make the respective regions coincide.

In addition, the image processor 217 can also display an index indicating an irradiation position (more generally, a region irradiated with an electromagnetic wave) of laser light in a superimposed manner on the second image data.

<Specific Example of Control Flow>

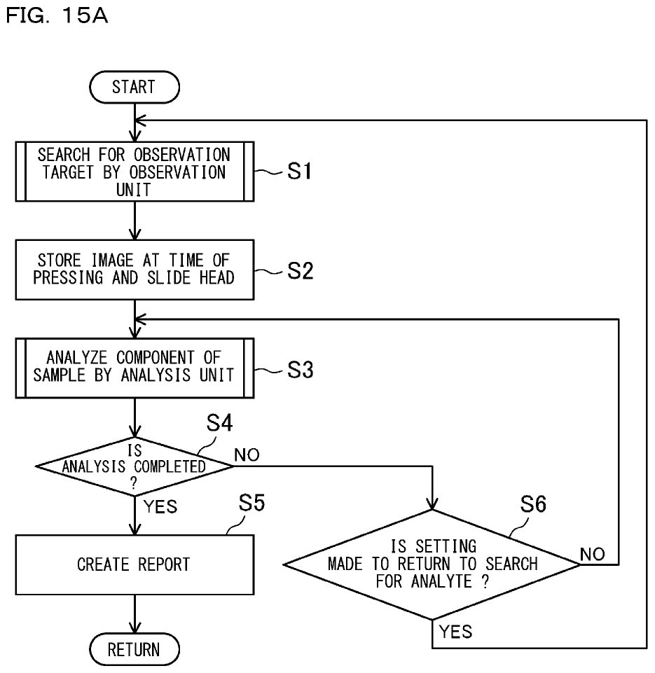

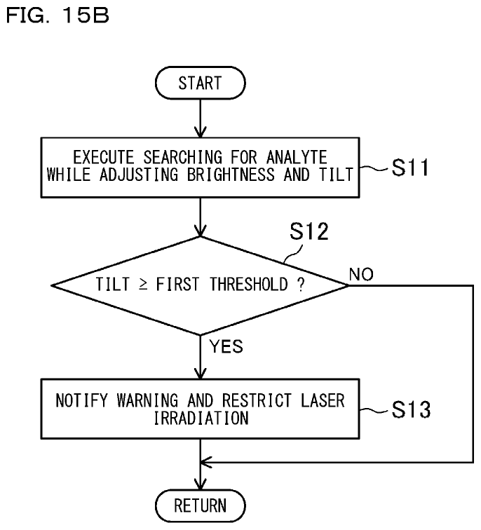

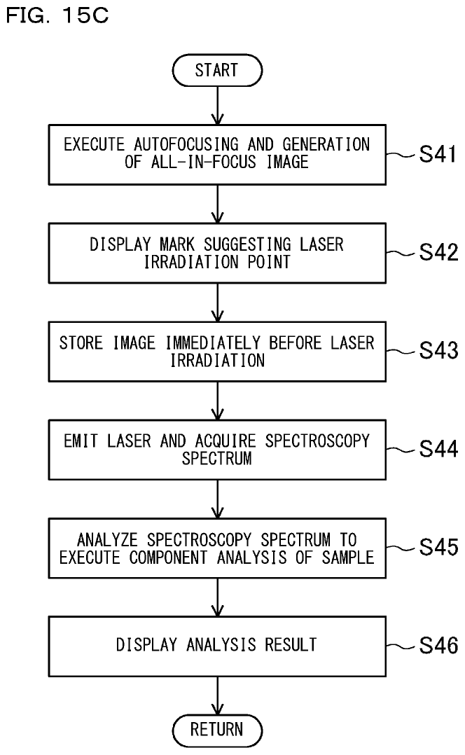

FIG. 15A is a flowchart illustrating a basic operation of the analysis and observation device A. Further, FIG. 15B is a flowchart illustrating an analyte search procedure by the observation unit 63, and FIG. 15C is a flowchart illustrating an analysis procedure of the sample SP by the analysis unit 62. FIGS. 16A to 16F are views illustrating display screens of the analysis and observation device A.

First, the observation unit 63 searches for an analyte in the first mode in step S1 of FIG. 15A. The processing performed in step S1 is illustrated in FIG. 15B. That is, step S1 in FIG. 15A includes steps S11 to S13 in FIG. 15B.

Here, prior to step S11 in FIG. 15B, the objective lens 92 having a desired magnification is selected by replacing only the objective lens 92 with a lens having a desired magnification or replacing the lens barrel 90 or the observation unit 63 in a state where the lens barrel 90 is held by the unit coupler 64. When the entire observation unit 63 is replaced, the observation unit 63 may be replaced together with the unit coupler 64, or only the observation unit 63 may be replaced by removing the observation unit 63 from the unit coupler 64.

Then, in step S11, the analysis and observation device A, particularly, the controller 21 in the same device searches for a portion (analyte) to be analyzed by the analysis unit 62 among portions of the sample SP while adjusting conditions such as the exposure time of the second camera 93 and the brightness of image data (hereinafter, also referred to as “first image data I1”) generated by the second camera 93, such as illumination light guided by the optical fiber cable C3, based on an operation input by the user. At this time, the controller 21 stores the first image data I1 generated by the second camera 93 as necessary.

Note that the adjustment of the exposure time of the second camera 93 and the adjustment of the brightness of the illumination light can be also configured to be automatically executed by the controller 21 based on a detection signal of the lens sensor Sw1 without accompanying the operation input by the user.

Further, during this step S11 or before or after the step S11, the observation optical system 9, and eventually, the entire head 6 are tilted by the tilting mechanism 45 at the time of searching for the analyte, for example, based on a manual operation by the user. The controller 21 detects the magnitude of the tilt θ at that time. The magnitude of the tilt θ is displayed on the display 22 together with the first image data I1 generated by the second camera 93.

FIG. 16A illustrates the display screen when the sample SP is captured from directly above (θ=±0°) in the first mode. In this case, a dialog T1 visually indicating the magnitude of the tilt θ can be displayed on the display 22 together with the first image data I1 corresponding to the tilt θ.

Meanwhile, FIG. 16C illustrates the display screen when the sample SP is captured from obliquely above (θ=)+XX° in the first mode. In this example, a sign of θ corresponds to a swinging direction of the head 6, and a positive sign is set for a rightward swing and a negative sign is set for a leftward swing. Of course, the positive and negative definitions are merely examples, and can be changed as appropriate.

In the subsequent step S12, the tilt determining section 211 determines the magnitude of the tilt θ. The processing proceeds to step S13 to notify the user of a warning and restrict the laser irradiation when the tilt θ exceeds the first threshold θmax, and skips step S13 and returns to the previous processing when the tilt θ is equal to or less than the first threshold θmax.

FIG. 16B illustrates a determination result notification screen corresponding to FIG. 16A. In this example, numerical data indicating the magnitude of the tilt θ and a character string indicating the determination result are displayed on a dialog T2. The latter character string indicates that the laser irradiation is allowed (emission OK), and is displayed in a state of being set to a predetermined display color. A button B1 is a button for starting component analysis by the analysis unit 62, and the button B2 is a button for stopping the component analysis.

Meanwhile, FIG. 16D illustrates a determination result notification screen corresponding to FIG. 16C. In this example, the dialog T2 indicates that the laser irradiation is not recommended (emission NG), and is displayed in a state of being set to a display color different from that in FIG. 16B. In this case, the laser irradiation may be restricted by hiding the button B1 illustrated in FIG. 16B, or a button B3 for forcibly starting the component analysis may be displayed on the display 22 as illustrated in FIG. 16D. For example, when the button B3 is pressed, the component analysis is started after a warning is issued to the user.

In a case where the processing illustrated in step S13 is completed or in a case where step S13 is skipped, for example, the user confirms whether there is no problem in the appearance of the sample SP, such as the brightness of the first image data I1 and an angle of the observation optical system 9. A control process that needs to be performed by the analysis and observation device A is returned to step S11 when there is a problem, and the flow illustrated in FIG. 15B is manually or automatically ended when there is no problem. As a result, the control process has completed step S1 in FIG. 15A.

Then, for example, when an analysis start button (see, for example, the button B1 in FIG. 16B) is pressed by the user, the control process proceeds from step S1 to step S2.

In step S2, the first image data I1 at the time of pressing the button is stored in the storage device 21b, and the mode switcher 214 operates the unit switching mechanism 65 to integrally slide and move the observation optical system 9 and the analysis optical system 7, so that the switching from the first mode to the second mode is executed.

FIG. 16E illustrates a display screen when the sample SP is captured from obliquely above (θ=)+XX° in the second mode. Image data illustrated in FIG. 16E is generated by the first camera 81 of the analysis optical system 7. Hereinafter, this is also referred to as the “second image data I2”.

As is clear from the comparison between FIGS. 16C and 16E, a center position and a tilt of the sample SP displayed in the second mode are substantially the same as a center position and a tilt of the sample SP displayed in the first mode.

Subsequently, in step S3 of FIG. 15A, component analysis of the sample SP by the analysis unit 62 is executed in the second mode. The processing performed in step S3 is illustrated in FIG. 15C. That is, step S3 in FIG. 15A includes steps S41 to S46 in FIG. 15C.

In the present embodiment, the reflective object lens 74 for component analysis has a shallower subject depth during observation than the objective lens 92 for observation. Therefore, the controller 21 in the controller main body 2 executes autofocus at each position in second image data I2 to generate an all-in-focus image in step S41 in FIG. 15C. As a result, it is possible to focus on substantially the entire second image data I2. At that time, capturing conditions, such as the exposure time of the first camera 81 and the light amount of illumination light emitted from the LED light source 79, can be brought as close as possible to capturing conditions in the first mode.

Further, in a case where the magnification of the objective lens 92 is lower than that of the reflective object lens 74, the above-described image processor 217 can display, on the display 22, only the first image data I1 stored in step S2 as a mapping image, and any point in the mapping image that has been captured as the second image data I2.

In the subsequent step S42, the image processor 217 displays a mark P1 suggesting an irradiation position of laser light (laser irradiation point) in an overlay manner on the second image data I2. The mark P1 indicates the alignment of the laser light. The user can confirm whether or not an analyte is appropriately set by checking a position of the mark P1. The image processor 217 can cause the control process to proceed based on an operation input (for example, a manual input by the user) indicating a result of the confirmation.

Further, when the analyte is not appropriately set in step S42, the head 6 drives the placement stage drive 53 to adjust a position of the placement stage 51 based on, for example, an operation input by the user. As a result, a relative position of the sample SP with respect to the mark P1 can be corrected.

Before executing step S43 subsequent to step S42, the user can press an analysis button B4 displayed on a dialog T3 in response to completion of the setting of the alignment of the laser light.

At that time, the user can confirm whether or not illumination light can be visually recognized, and allow the emission of laser light only when the illumination light is not visually recognizable. For example, it is possible to adopt a configuration in which a button displayed as “illumination light is not visually recognizable” is displayed on the display 22, and the analysis button B4 is displayed on the display 22 only when such a button is pressed.

Note that the controller 21 can also determine the tilt θ of the head 6 in the second mode as described in the description of the mode switcher 214. In such a configuration, the controller 21 can perform the same processing as steps S12 and S13 in FIG. 15B, for example, at a timing immediately after the analysis button B4 is pressed (the timing after the pressing and before the execution of step S43).

In the subsequent step S43, the controller 21 stores the second image data I2 immediately before the irradiation with the laser light in the storage device 21b. In the subsequent step S44, the controller 21 causes the analysis optical system 7 to emit the laser light to the sample SP via the laser controller 213.

In step S44, the first and second detectors 77A and 77B receive light emitted due to plasma occurring on the sample SP. At that time, light reception timings of the first and second detectors 77A and 77B are set to be synchronized with an emission timing of the laser light. The spectrum acquirer 215 acquires an intensity distribution spectrum in accordance with the emission timing of the laser light.

In the subsequent step S45, the spectrum analyzer 216 analyzes the intensity distribution spectrum to execute analysis of components and component ratios of elements contained in the sample SP and estimation of a material based on the component ratios (see a dialog T4 in FIG. 16F).

In the subsequent step S46, the image processor 217 displays the analysis result in step S45 on the display 22 as illustrated in a dialog T5 in FIG. 16G. Thereafter, the controller 21 ends the flow illustrated in FIG. 15C. If this flow ends, the control process proceeds from step S3 in FIG. 15A to step S4 in the same drawing.

In step S4, it is determined whether the component analysis of the sample SP has been completed, and the control process proceeds to step S5 when the component analysis has been completed (step S5: YES). This determination is executed by the controller 21 based on, for example, an operation input by the user. In step S5, the controller 21 creates a report in which the analysis result is described, and ends the flow illustrated in FIG. 15A.

On the other hand, the processing proceeds to step S6 when the component analysis is not completed (step S4: NO), returns to step S1 when returning to the search for the analyte is set (step S6: YES), and returns to step S3 to execute the above-described processing again when the setting is made such that the change of the analyte is unnecessary (step S6: NO). Note that the setting related to step S6 may be appropriately read from the storage device 21b or the like, which has been created in advance, or may be generated based on an operation input or the like by the user every operation input.

<Main Features of Analysis and Observation Device A>

(Feature of Unit Switching Mechanism 65)

As described above, according to the present embodiment, the analysis and observation device A moves the relative positions of the observation optical system 9 and the analysis optical system 7 with respect to the placement stage 51 to execute the capturing of the sample SP by the observation optical system 9 and the irradiation of the laser light at the time of generating the intensity distribution spectrum by the analysis optical system 7 on the identical point in the sample SP as illustrated in FIG. 11B and the like. As a result, it is possible to eliminate a deviation between an observation position by the observation optical system 9 and an analysis position by the analysis optical system 7, and eventually, it is possible to improve the usability of the device.

Further, according to the present embodiment, the observation optical system 9 and the analysis optical system 7 are configured as independent optical systems, and thus, each of the optical systems can have a specification suitable for each application. As a result, the performance of each of the optical systems can be optimized as much as possible.

Further, the analysis and observation device A according to the present embodiment can be configured as an all-in-one type device as illustrated in FIG. 11B and the like, and can implement from observation to analysis only by attaching the respective optical systems to the stand 4. This is advantageous in terms of improving the usability of the device.

Further, the unit coupler 64 holds the lens barrel 90, and eventually, the observation unit 63 so that the relative position of the analysis optical axis Aa with respect to the observation optical axis Ao becomes constant as illustrated in FIG. 10 and the like. Therefore, it is possible to perform the observation and analysis on the identical point by relatively moving the observation optical system 9 and the analysis optical system 7 by the distance D1 corresponding to the relative position.

Further, the two optical axes Ao and Aa are arranged along the moving direction of both the optical systems 7 and 9 by the unit switching mechanism 65 as illustrated in FIG. 10 and the like, which is advantageous in terms of performing the observation and analysis on the identical point.

Further, the unit coupler 64 is attached to the outer surface (the protrusion 70c) of the analysis housing 70 as illustrated in FIG. 2 and the like, and thus, the analysis optical system 7 and the observation optical system 9 can be configured as detachable and completely independent optical units, which is advantageous in terms of adopting the specification suitable for each application.

Here, the lens barrel 90 and the observation unit 63 are attached to the outer surface of the analysis housing 70 via the unit coupler 64, and thus, it is easy to replace the observation optical system 9 together with the lens barrel 90 or the observation unit 63, and at the same time, it is extremely easy to replace a part of the observation optical system 9 (for example, the objective lens 92) by manual work or the like. This is advantageous in terms of improving the usability of the device.

Further, the unit coupler 64 is configured to selectively hold any one of the plurality of types of lens barrels 90, 90′, and 90″ or the observation units 63, 63′, and 63″ as illustrated in FIG. 9, and thus, it becomes easy to replace the observation optical system 9 having desired characteristics, such as the magnification of the objective lens 92, together with the lens barrel 90 or the observation unit 63, which is advantageous in terms of improving the usability of the device.

Further, the observation and analysis for the sample SP can be performed from the same angle before and after the movement by the unit switching mechanism 65 as illustrated in FIG. 11B and the like. As a result, the deviation between the observation position by the observation optical system 9 and the analysis position by the analysis optical system 7 is further eliminated, which is more advantageous in terms of improving the usability of the device.

Further, the analysis and observation device A according to the present embodiment is configured such that the controller 21 that performs the processing related to the observation optical system 9 and the controller 21 that performs the processing related to the analysis optical system 7 are common as illustrated in FIG. 1 and the like. As a result, it is possible to share the controller 21 while providing the two independent optical systems 7 and 9, and it is possible to reduce the number of components and smoothly execute the processing related to both of the two optical systems 7 and 9.

Further, the unit switching mechanism 65 is configured to move the observation optical system 9 and the analysis optical system 7, instead of the placement stage 51, at the time of moving the relative positions of the observation optical system 9 and the analysis optical system 7 with respect to the placement stage 51 as illustrated in FIG. 11B and the like. With this configuration, it is possible to analyze the same point as the observation point regardless of a position where the sample SP is placed on the stage 5.

(Feature of Tilting Mechanism 45)

Further, according to the present embodiment, the tilting mechanism 45 tilts at least the observation optical system 9 between the analysis optical system 7 and the observation optical system 9 with respect to the predetermined reference axis As perpendicular to the placement surface 51a as illustrated in FIG. 12B and the like. The sample SP can be observed from various angles such as an oblique direction by mounting the tiltable observation optical system 9 on the analysis and observation device A. As a result, the user can easily grasp the observation position of the sample SP.

Further, the analysis optical system 7 and the observation optical system 9 are integrally tilted in the state where the relative position of the observation optical axis Ao with respect to the analysis optical axis Aa is held as illustrated in FIGS. 10, 12B, and the like, and thus, the sample SP can be irradiated with the laser light from various directions such as the oblique direction. As a result, it is possible to perform component analysis on the samples SP having various shapes such as a structure erected in the vertical direction.

In general, if laser light is emitted in a state where the analysis optical system 7 is excessively tilted, there is a possibility that the laser light hits a retina of a human body or the like. Therefore, the safety of the analysis and observation device A can be enhanced by restricting the emission of laser light according to the tilt θ as illustrated in step S13, step S14, and the like in FIG. 15B.

Further, it is possible to more reliably suppress the emission of laser light by using the shielding member 83 arranged in the analysis housing 70 as illustrated in FIG. 7, which is advantageous in terms of enhancing the safety of the analysis and observation device A.

Further, it is possible to notify the user of various types of information, such as the tilt θ of the analysis optical system 7, by performing the notification based on the detection results of the first and second tilt sensors Sw3 and Sw4 as illustrated in FIG. 16D. This is advantageous in terms of enhancing the safety of the analysis and observation device A.

Further, it is possible to notify the user of information corresponding to the posture of the analysis optical system 7 by switching the notification content according to the magnitude of the tilt θ as illustrated in FIGS. 16B and 16D. This is advantageous in terms of enhancing the safety of the analysis and observation device A.

Further, the notification indicating that the emission of laser light is not recommended is included in the notification that can be realized by the information controller 212 as illustrated in FIG. 16D, and thus, more reliable attention can be attracted to the user, for example, as compared with a configuration in which only the tilt of the analysis optical system 7 is notified. This is advantageous in terms of enhancing the safety of the analysis and observation device A.

Further, the control according to the tilt θ is not executed (the emission of laser light is allowed regardless of the magnitude of the tilt θ) in the shielding state where the safety is secured by the cover member 61b illustrated in FIG. 6 and the like or in the state where the shielding cover 10 is attached to the objective lens 92 or the analysis housing 70 as illustrated in FIG. 17. The emission of laser light is restricted only in the non-shielding state where there is a possibility that the safety is not secured or in the state where the shielding cover 10 is not attached to the objective lens 92 or the analysis housing 70. Thus, the emission of laser light can be controlled after appropriately determining a status in which the emission needs to be restricted.

Further, the unit switching mechanism 65 moves the relative positions of the observation optical system 9 and the analysis optical system 7 in the state where at least the observation optical system 9 is held in the tilted posture by the tilting mechanism 45 as indicated by the double-headed arrow A1 in FIG. 15B. As a result, the sample SP can be observed from a desired angle by the observation optical system 9, and the substantially same position as the observation position can be analyzed by the analysis optical system 7. This is advantageous in terms of eliminating the deviation between the observation position by the observation optical system 9 and the analysis position by the analysis optical system 7 and improving the usability of the device.

(Other Features)

Further, as illustrated in FIG. 6 and the like, the analysis and observation device A according to the present embodiment is an analysis device, which collects laser light, irradiates the sample SP as an analyte, with the laser light, and analyzes components contained in the sample SP based on a spectroscopy spectrum of light generated from the sample SP, and includes: the analysis housing 70 that accommodates the analysis optical system 7; the stand 4 that holds the analysis housing 70; an observation housing (housing of the observation unit 63) that accommodates the observation optical system 9; and the unit coupler 64 that is provided in the stand 4 or the analysis housing 70 and serves as a holder that holds the observation housing.

Here, the analysis optical system 7 includes: the electromagnetic wave emitter 71 as the laser oscillator that emits an electromagnetic wave (in particular, laser light in the present embodiment) to the sample SP; and the first and second detectors 77A and 77B as the detectors that disperse light generated in the sample SP in response to the electromagnetic wave when the sample SP is irradiated with the electromagnetic wave (laser light) emitted from the electromagnetic wave emitter 71.

On the other hand, the observation optical system 9 accommodates the observation optical system 9 including the objective lens 92 that collects the light from the sample SP and the second camera 93 as the camera that detects a light reception amount of light received through the objective lens 92 and performs analysis of the sample SP.

The analysis and observation device A further includes: the controller 21 that performs component analysis of the sample SP based on the intensity distribution spectrum of the light received by the first and second detectors 77A and 77B and generation of image data of the sample SP based on the light reception amount acquired by the second camera 93.

In this manner, the analysis and observation device A according to the present embodiment is configured such that the unit coupler 64 is provided in the stand 4 or the analysis housing 70, and the observation housing is attached via the unit coupler 64. As a result, the observation optical system 9 and the analysis optical system 7 can be configured as completely independent units, and specifications of the respective units can be optimized separately.

Further, it becomes easy for the analysis optical system 7 to analyze the same point as a place observed by the observation optical system 9 by integrally causing horizontal movement of the analysis optical system 7 and the observation optical system 9 with respect to the stage 5 as illustrated in FIG. 11B and the like.

Further, it is possible to easily perform work such as attachment and detachment of the objective lens 92 by arranging the lens barrel 90 on the front side of the analysis housing 70 as illustrated in FIG. 6 and the like. Further, the layout of the observation optical system 9, lighter than the analysis optical system 7, on the front side is advantageous in terms of reducing a load acting on the guide rail 65a (more specifically, a moment of a force acting on the distal end of the guide rail 65a) when the observation optical system 9 and the analysis optical system 7 are slid to the front side, and stabilizing the support of both the optical systems 7 and 9 without causing rattling of both the optical systems 7 and 9. Further, the layout of the observation optical system 9 on the front side makes attachment and detachment easy at the time of selecting the optimum observation optical system 9.

### Other Embodiments

(Modification Related to Hardware Configuration)

In the above embodiment, the analysis optical system 7 is configured to be tilted integrally with the observation optical system 9, but the present disclosure is not limited to such a configuration. It is sufficient for the tilting mechanism 45 to incline at least the observation optical system 9. When a configuration is adopted in which only the observation optical system 9 is tilted, laser light as an electromagnetic wave is emitted downward from immediately above the sample SP.

In the above embodiment, the unit switching mechanism 65 is configured to move the observation optical system 9 and the analysis optical system 7, instead of the placement stage 51, at the time of moving the relative positions of the observation optical system 9 and the analysis optical system 7 with respect to the placement stage 51. With such a configuration, a vibration of the stage 5 can be suppressed, and a positional variation of an observation target caused by the movement of the stage 5 can be suppressed. However, the present disclosure is not limited to such a configuration. It is also possible to adopt a configuration in which the placement stage 51 is moved, instead of the observation optical system 9 and the analysis optical system 7. Furthermore, a configuration may be adopted in which both the observation optical system 9 and the analysis optical system 7 are integrally moved, and the placement stage 51 is also moved such that the identical point can be observed and analyzed.

Although the above embodiment is configured such that the stand 4 supports the analysis optical system 7 from the rear side and the observation optical system 9 is arranged on the front side of the analysis optical system 7, the present disclosure is not limited to such a configuration. The observation optical system 9 may be arranged between the stand 4 and the analysis optical system 7.

Further, the observation optical system 9 can also be arranged inside the analysis housing 70, instead of arranging the observation optical system 9 outside the analysis housing 70 as in the above embodiment. In this case, the observation optical system 9 may be arranged inside the analysis housing 70 in a state of being accommodated in a housing of the entire observation unit 63 including the lens barrel 90, or components included in the observation optical system 9, that is, the camera for observation, the lens barrel, and the like, may be arranged inside the analysis housing 70 in a state of not being accommodated in such a housing.

Although the above embodiment is configured such that the unit coupler 64 as the lens barrel holder fixes the lens barrel 90, and eventually, the observation unit 63 to the analysis optical system 7, the present disclosure is not limited to such a configuration. The relative position of the analysis optical axis Aa with respect to the observation optical axis Ao can be also fixed by holding the second camera 93, instead of the observation unit 63.

Further, the above embodiment is configured such that the observation optical axis Ao and the analysis optical axis As ae parallel to each other, but the present disclosure is not limited to such a configuration. The analysis optical system 7 and the observation optical system 9 can also be arranged such that the observation optical axis Ao and the analysis optical axis As are twisted.

(Modification Related to Restriction of Emission of Laser Light)

Although the above embodiment is configured such that the emission of laser light is allowed or restricted according to the magnitude of the tilt θ, the present disclosure is not limited to such a configuration.

Specifically, according to a modification of the present disclosure, the analysis optical system 7 restricts emission of laser light regardless of the tilt θ of the analysis optical system 7 with respect to the reference axis As in a state where the analysis optical system 7 and the observation optical system 9 are integrally tilted.

According to this modification, the emission of laser light is restricted regardless of the magnitude of the tilt θ in the state where the analysis optical system 7 is tilted. As a result, it is possible to implement a configuration improved on the safer side.

(Modification of Analysis Method)

Although the analysis and observation device A according to the above embodiment is configured to perform the component analysis using the LIBS method by causing the electromagnetic wave emitter 71 to emit the laser light as the electromagnetic wave, the present disclosure is not limited to such a configuration.

For example, infrared light may be used as the electromagnetic wave to perform analysis by infrared spectroscopy, instead of the LIBS method. Specifically, a chemical structure of a molecule contained in an observation target may be analyzed by irradiating the observation target with the infrared light and measuring transmitted or reflection light. Monochromatic light may be used as the electromagnetic wave to perform analysis by Raman spectroscopy in which physical properties, such as crystallinity of an observation target, are investigated using Raman scattered light generated by irradiating the observation target with the monochromatic light. Further, light in an ultraviolet region, a visible region, and an infrared region of about 180 to 3000 nm may be used as the electromagnetic wave to perform analysis by ultraviolet-visible near-infrared spectroscopy. Specifically, qualitative and quantitative analysis of a target component contained in an observation target may be performed by irradiating the observation target with the electromagnetic wave and measuring transmitted or reflection light. Furthermore, spectroscopic analysis of an X-ray region may be performed by using an X-ray as the electromagnetic wave. Specifically, X-ray fluorescence analysis may be performed in which an observation target (specimen) is irradiated with X-rays, and elements of the observation target are analyzed by energy and intensity of fluorescent X-rays which are unique X-rays generated by the irradiation. An electron beam may be used instead of the electromagnetic wave to analyze a surface of an observation target based on energy and intensity of reflected electrons generated by irradiating the observation target with the electron beam. The configuration according to the present disclosure is also applicable to a case of performing spectroscopy in the above analysis.

What is claimed is:

1. A microscope for magnifying observation of an observation target, the microscope comprising
a placement stage on which the observation target is placed;
an observation optical system including a first objective lens that collects light from the observation target placed on the placement stage, and a camera that detects a light reception amount of the light from the observation target received through the first objective lens to capture an image of the observation target;
an analysis optical system including an electromagnetic wave emitter that emits an electromagnetic wave for analyzing the observation target, a second objective lens that collects an electromagnetic wave from the observation target in response to irradiation of the electromagnetic wave, and a detector that generates an intensity distribution spectrum which is an intensity distribution for each wavelength of the electromagnetic wave generated on the observation target and collected by the second objective lens; and
a horizontal drive mechanism which moves relative positions of the observation optical system and the analysis optical system with respect to the placement stage along a horizontal direction such that the capturing of the observation target by the observation optical system and the irradiation of the electromagnetic wave by the analysis optical system are executable on an identical point in the observation target.

2. The microscope according to claim 1, further comprising
a stand to which the placement stage, the observation optical system, and the analysis optical system are attachable.

3. The microscope according to claim 1, wherein
an optical axis of the first objective lens and an optical axis of the second objective lens are provided so as to be parallel to each other, and
the capturing of the observation target by the observation optical system and the irradiation of the electromagnetic wave by the analysis optical system are executed on the identical point from an identical direction before and after the movement by moving the relative position in the horizontal direction by the horizontal drive mechanism.

4. The microscope according to claim 1, further comprising:
an observation unit accommodating the observation optical system; and
a lens barrel holder which fixes the observation unit with respect to the analysis optical system to fix a relative position of an optical axis of the second objective lens with respect to an optical axis of the first objective lens.

5. The microscope according to claim 4, wherein
the respective optical axes of the observation optical system and the analysis optical system are arranged so as to intersect the horizontal direction as the lens barrel holder holds the observation unit.

6. The microscope according to claim 4, further comprising
an analysis housing that accommodates the analysis optical system,
wherein the lens barrel holder in a state of holding the observation unit is arranged outside the analysis housing.

7. The microscope according to claim 4, wherein
the lens barrel holder is configured to selectively hold any one of a plurality of types of the observation units accommodating the observation optical systems different from each other.

8. The microscope according to claim 1, wherein
the horizontal drive mechanism is operated to switch between a first mode in which the first objective lens faces the observation target and a second mode in which the second objective lens faces the observation target, and
image generation of the observation target by the observation optical system and the irradiation of the electromagnetic wave by the analysis optical system are performed on the identical point from an identical direction at timings before and after the switching between the first mode and the second mode.

9. The microscope according to claim 1, further comprising
a controller electrically connected to the observation optical system and the analysis optical system,
wherein the controller is configured to be capable of executing both of generation of image data of the observation target based on a light reception amount of the light from the observation target and analysis of a substance contained in the observation target based on the intensity distribution spectrum.

10. The microscope according to claim 9, further comprising:
an observation unit accommodating the observation optical system which includes the first objective lens; and
a lens barrel holder which fixes the observation unit with respect to the analysis optical system to fix a relative position of an optical axis of the second objective lens with respect to an optical axis of the first objective lens,
wherein the lens barrel holder is configured to selectively hold any one of a plurality of types of the observation units accommodating the observation optical systems different from each other and the controller identifies at least a type of the first objective lens corresponding to the observation unit fixed to the analysis optical system by the lens barrel holder, and executes processing related to the capturing of the observation target based on the identification result.

11. The microscope according to claim 1, wherein
the electromagnetic wave emitter includes a laser light source that emits laser light as the electromagnetic wave.

12. The microscope according to claim 11, wherein
the second objective lens collects plasma light generated from the observation target in response to the irradiation of the laser light emitted by the electromagnetic wave emitter, and
the detector generates an intensity distribution spectrum which is an intensity distribution for each wavelength of the plasma light generated on the observation target and collected by the second objective lens.

13. The microscope according to claim 1, further comprising
a tilting mechanism that tilts the analysis optical system and the observation optical system together with respect to a predetermined reference axis perpendicular to an upper surface of the placement stage.
